(19) United States
(12) Patent Application Publication
(10) Pub. No.: US 2026/0092222 A1
(43) Pub. Date: Apr. 2, 2026

(54) PLASTIC PROCESSING METHOD AND PROCESSING SYSTEM

(71) Applicants: CHINA PETROLEUM & CHEMICAL CORPORATION, Beijing (CN); SINOPEC RESEARCH INSTITUTE OF PETROLEUM PROCESSING CO., LTD., Beijing (CN)

(72) Inventors: Mingfeng LI, Beijing (CN); Lei REN, Beijing (CN); Zifeng LI, Beijing (CN); Yong WANG, Beijing (CN); Ming DONG, Beijing (CN); Haiping SHEN, Beijing (CN); Yanbo HOU, Beijing (CN); Zhemin ZHANG, Beijing (CN); Ying HAN, Beijing (CN); Wanbo LI, Beijing (CN)

(21) Appl. No.: 19/104,455

(22) PCT Filed: Aug. 17, 2023
(86) PCT No.: PCT/CN2023/113550

§ 371 Date: Mar. 11, 2025

(30) Foreign Application Priority Data
Aug. 17, 2022 (CN) 202210989471.4
Aug. 31, 2022 (CN) 202211057426.1
Oct. 27, 2022 (CN) 202211328729.2

(51) Int. Cl. C10G 11/18; B01D 53/68; B01D 53/78; B09B 3/35; B09B 3/40; B09B 3/70; B09B 101/77; C10G 11/05

(52) U.S. Cl. CPC C10G 11/187; B01D 53/68; B01D 53/78; B09B 3/35; B09B 3/40; B09B 3/70; C10G 11/05; C10G 11/182; B01D 2251/304; B01D 2251/604; B01D 2257/2045; B01D 2258/02; B09B 2101/77; C10G 2300/1003; C10G 2300/202; C10G 2400/02; C10G 2400/04; C10G 2400/06

(57) ABSTRACT

A plastic processing method includes the following steps: S1. the plastic to be treated is sent to a liquefaction unit for liquefaction treatment to produce a liquefied material; S2. subjecting the liquefied material to heat treatment in a viscosity reduction unit to reduce its viscosity to produce a viscosity-reduced liquefied material; S3. the viscosity-reduced liquefied material is sent to a cracking reaction unit for cracking reaction to produce a reaction product; S4. the reaction product is sent to a separation unit for separation treatment. The system for carrying out the plastic processing method has a liquefaction unit, a viscosity reduction unit, a cracking reaction unit, and a separation unit.

### TECHNICAL FIELD

The present disclosure relates to the field of plastic resource recycling, and in particular, to a processing method and a processing system for liquefaction, viscosity reduction and reaction of waste plastics.

### BACKGROUND OF ART

Plastics appear in large quantities in people's daily lives as packaging materials. Used waste plastics usually cannot decompose by themselves in nature. Only a few types of waste plastics can be reprocessed and reused through specific recycling channels, and a large amount of waste plastics enter landfills as domestic waste. Since waste plastics are not easy to decompose, they occupy a lot of space. Especially in recent years, the formation amount of waste plastics has increased rapidly, and it has become an urgent task to recycle waste plastics quickly and greenly.

The simplest way to deal with waste plastic is to incinerate it directly, but direct incineration will produce toxic gases that are harmful to the human body and cause secondary environmental pollution.

At present, the recycling technology of converting waste plastics into oil products has alleviated the pollution problem caused by waste plastics on the one hand, and realized the recycling of waste plastics on the other hand, which is an important direction for the resource treatment of waste plastics. For example, CN107746722A, CN101374930A, CN10461030A, CN109401774A, CN112538363A, and CN106118707B disclose some recycling technologies of converting waste plastics into oil products.

There are some difficulties in recycling waste plastics: (1) when waste plastics contain polyvinyl chloride, polyvinyl chloride decomposes into HCl when heated, which can quickly react with double bonds in the raw materials to form chlorinated hydrocarbons, making it difficult for traditional reaction devices to efficiently remove chlorine from waste plastics; (2) waste plastics are high-molecular polymers. Due to their huge molecular weight and solid state, heat transfer inside the plastic is very slow. Traditional heating methods will cause excessive cracking of the external part of the plastic while the internal part of the plastic remains solid. As a result, the pyrolysis coking rate of the waste plastic is high and the gas yield is high; (3) the density of waste plastic is low, and the rate at which waste plastics enter the reaction device is low. The processing scale of existing technologies is small and cannot meet the needs of modern large-scale recycling.

### SUMMARY OF THE INVENTION

One purpose of the present disclosure is to provide a processing method and processing system for fluidized cracking of waste plastics, which can continuously perform fluidized cracking of waste materials, achieve effective utilization of waste plastic resources, crack waste plastics into low molecular weight products, and effectively remove impurities in the products.

In order to achieve the above purpose, a first aspect of the present disclosure provides a processing method for fluidized cracking of waste plastics, the method comprises the following steps:
S1. the waste plastic to be treated is sent to a liquefaction unit for waste plastics for liquefaction treatment to produce a liquefied waste plastic;
S2. the liquefied waste plastic is sent to a viscosity reduction unit for waste plastics for a viscosity reduction treatment to produce a viscosity-reduced liquefied waste plastic oil and a first dry gas;
S3. the viscosity-reduced liquefied waste plastic oil is sent to a contact-cracking reaction unit, and contacted with a contact agent in a fluidized state to perform a cracking reaction to produce a reaction product and a spent contact agent;
S4. the reaction product is sent to a separation unit to perform a separation treatment to produce, for example, a second dry gas, a liquefied gas, a gasoline fraction, a diesel fraction and a gas oil fraction; the spent contact agent is sent to a regeneration unit, and the spent contact agent is regenerated in the presence of oxygen gas to produce a regenerated contact agent and a regeneration flue gas; and the regenerated contact agent is returned to the contact-cracking reaction unit for continuous use.

Optionally, before step S1, the method further comprises: a chlorine-containing waste plastic raw material is fed into a heat melting-dehydration-dechlorination unit for waste plastics, and the chlorine-containing waste plastic raw material is subjected to melting-dehydration treatment at a first temperature condition to produce a dehydrated waste plastic; then the dehydrated waste plastic is heated to a second temperature for dechlorination treatment to produce a dehydrated and dechlorinated waste plastic and a hydrogen chloride-containing gas; the dehydrated and dechlorinated waste plastic is subjected to cooling treatment and comminution treatment successively in a cooling and comminution unit to produce dehydrated and dechlorinated waste plastic particles; the dehydrated and dechlorinated waste plastic particles are sent to the liquefaction unit for waste plastics; or the dehydrated and dechlorinated waste plastic is directly sent to the liquefaction unit for waste plastics; or
optionally, before step S1, the method further comprises: a chlorine-containing waste plastic raw material is sent to a preliminary melting-liquefaction-dechlorination unit for waste plastics to perform a heat melting-dechlorination treatment to produce a hydrogen chloride-containing gas phase material and a dechlorinated waste plastic material; the dechlorinated waste plastic material is sent to the liquefaction unit for waste plastics; or the dechlorinated waste plastic material is subjected to cooling treatment and comminution treatment successively to produce dechlorinated waste plastic particles; the dechlorinated waste plastic particles are sent to the liquefaction unit for waste plastics.

Optionally, the method further comprises: the hydrogen chloride-containing gas is sent to a hydrogen chloride absorption unit to contact a hydrogen chloride absorbent to perform a hydrogen chloride absorption treatment; optionally, the hydrogen chloride-containing gas is sent to a hydrogen chloride absorption unit under the action of a vacuum system; wherein the hydrogen chloride absorbent is water or an alkali solution with a pH value greater than 7; optionally, the alkali solution comprises one or more of a sodium hydroxide solution, a potassium hydroxide solution, a calcium hydroxide solution, a sodium bicarbonate solution, a sodium carbonate solution and an ammonia solution.

Optionally, the cracking reaction carried out in the contact-cracking reaction unit in step S3 also produces an ash with charcoal; the method further comprises: the ash with charcoal and a spent contact agent are sent to a regeneration unit, and in the presence of oxygen gas, the spent contact agent and the charcoal of the ash with charcoal are subjected to a complete combustion reaction to produce a regeneration flue gas and a regenerated contact agent; preferably, the method further comprises: at least a part of a first dry gas and/or at least a part of a second dry gas are sent to the regeneration unit, and in the presence of oxygen gas and dry gas, the spent contact agent and the ash with charcoal are subjected to a complete combustion reaction to produce a regeneration flue gas and a regenerated contact agent; preferably, based on the total weight of the spent contact agent, the spent contact agent has a charcoal content of 0.5-5.0 wt %.

Optionally, in step S1, a heating liquefaction transportation equipment is used in the liquefaction unit for waste plastics, preferably, the liquefaction treatment is carried out in a quick heating liquefaction transportation equipment; optionally, the heating liquefaction transportation equipment include a first screw-type heating transportation equipment; preferably, the first screw-type heating transportation equipment is a twin screw-type or single screw-type heating transportation equipment with heating; preferably, the condition of the liquefaction treatment includes: an outlet temperature is 370-480° C., e.g. 380-480° C., 380-450° C. or 400-450° C.; a residence time is 5-30 min, e.g. 5-20 min, or 5-15 min. The feeding pressure of the heating liquefaction transportation equipment can be an ordinary pressure or a reduced pressure or an increased pressure. For example, the feeding pressure can be an ordinary pressure, or 0-0.6 MPa, e.g., 0.1-0.3 MPa. Unless otherwise specified, the pressure used herein is a gauge pressure. The pressure of the liquefaction treatment is the internal pressure of the heating liquefaction transportation equipment.

Optionally, in step S2, a viscosity reduction reactor is used in the viscosity reduction unit for waste plastics to perform the viscosity reduction treatment; preferably, the viscosity reduction reactor is an adiabatic reactor; preferably, the condition of the viscosity reduction treatment includes: the reaction temperature is 350-450° C., e.g. 370-450° C., 380-420° C., 350-400° C., 370-410° C., 390-450° C. or 390-420° C.; the residence time is 10-200 min, from an economic viewpoint, the residence time is not greater than 200 min, e.g. not greater than 180 min, the residence time is e.g. 10-180 min, 15-120 min, 20-120 min, 20-90 min, 30-120 min, 30-90 min, 50-90 min, 50-70 min, 20-60 min, or 30-70 min.

The pressure of the viscosity reduction treatment is not particularly limited, and the viscosity reduction treatment may be performed under an ordinary pressure or a reduced pressure or an increased pressure. For example, the pressure of the viscosity reduction treatment can be an ordinary pressure, or 0-0.6 MPa, e.g., 0.1-0.3 MPa. Unless otherwise specified, the pressure used herein is a gauge pressure.

When the viscosity reduction treatment is carried out in the viscosity reduction reactor, the material sent to the reactor is cracked, so that the viscosity is further reduced. The viscosity reduction reactor can ensure that the temperature of the material sent to the reactor does not significantly change. Since the cracking is endothermic, additional heat is required, if necessary, to ensure that the temperature of the material sent to the reactor does not significantly change. Therefore, in a preferred embodiment, the viscosity reduction reactor is provided with a temperature-control and heating device so that it can be achieved that the temperature of the material sent to the reactor does not change significantly. Herein “the temperature of the material sent to the reactor does not significantly change” means that the temperature is maintained within a range of 90%-110%, e.g. 92%-108%, or 95%-105%, or 98%-102% of the temperature of the material sent to the reactor (for example, the temperature of the material sent to the reactor can be represented by the reactor outlet temperature). The condition of the viscosity reduction treatment can allow the material leaving the reactor after the viscosity reduction treatment to have a viscosity of less than 12000 cP@200° C., preferably less than 5000 cP@200° C., e.g. 100-4000 cP@200° C., 100-3000 cP@200° C., 100-2000 cP@200° C., 100-1000 cP@200° C., 200-1500 cP@200° C., 200-1000 cP@200° C. The viscosity is measured using a rotational viscometer according to SY/T 0520-2008.

Optionally, in step S3, the condition of the cracking reaction includes: the reaction temperature is 490-750° C., the weight hourly space velocity is 1-100h⁻¹, the mass ratio of the contact agent to the waste plastic to be treated is 5-30:1; preferably, the reaction temperature is 500-650° C., the weight hourly space velocity is 3-60h⁻¹, the mass ratio of the contact agent to the waste plastic to be treated is 6-20:1; preferably, the viscosity-reduced liquefied waste plastic oil and steam are sent to the contact-cracking reaction unit; preferably, the mass ratio of steam to the waste plastic to be treated is 0.05-1:1, e.g., 0.1-0.5:1.

The pressure of the cracking reaction is not particularly limited, and the cracking reaction may be performed under an ordinary pressure or a reduced pressure or an increased pressure. For example, the pressure of the cracking reaction can be an ordinary pressure, or 0-0.6 MPa, e.g., 0.1-0.3 MPa. Unless otherwise specified, the pressure used herein is a gauge pressure.

Optionally, in step S3, the contact agent is one or more of silica/alumina material catalyst, quartz sand or coal tar powder; preferably, the contact agent has a particle size of 20-3000 μm; optionally, the silica/alumina material is selected from a molecular sieve-containing catalyst and/or a molecular sieve-free catalyst; preferably, the molecular sieve-containing catalyst is one or more of a catalyst containing one or more molecular sieves of X molecular sieve, Y molecular sieve, mordenite, ZSM-5, pillared clay molecular sieve, and SAPO, and a waste FCC catalyst; preferably, the molecular sieve-free catalyst is a catalyst prepared with one or more of a first Raw Material as raw material, the first Raw Material includes amorphous silica-alumina, clay, kaolin, montmorillonite, rectorite, illite, chlorite, pseudo-boehmite and silica; or the molecular sieve-free catalyst is a catalyst prepared from one or more of a second Raw Material treated by acid washing, calcining and sieving as raw material, the second Raw Material includes amorphous silica-alumina, clay, kaolin, montmorillonite, rectorite, illite and chlorite; or a catalyst prepared from one or more of the second Raw Material treated by acid washing, calcining and sieving and pseudo-boehmite and/or silica as raw material; optionally, the coal coke powder is coal powder and/or petroleum coke powder.

Optionally, the regeneration is carried out in a dense-phase fluidized bed regenerator; preferably, the regeneration condition includes: the residence time of air is 0.5-60s, e.g. 1.0-10 s, the dense bed has a gasification temperature of 600-750° C., e.g. 600-700° C., the introduced gas is a gas having an oxygen gas content of 10-50 vol %, the dense bed has a linear velocity of 0.05-0.6 m/s, e.g., 0.2-0.4 m/s.

Optionally, the heat melting-dehydration-dechlorination unit for waste plastics includes a second screw-type heating transportation equipment and a vacuum device communicated with the second screw-type heating transportation equipment. Preferably, the second screw-type heating transportation equipment is a twin screw-type or single screw-type transportation equipment. Preferably, the condition of the melting-dehydration treatment includes: the first temperature is 100-170° C., e.g., 120-150° C.; the time is 0.05-1h, e.g., 0.05-0.5h; the feeding rate of the chlorine-containing waste plastic raw material is 5-5000 kg/h, e.g., 100-4000 kg/h. Preferably, the condition of the dechlorination treatment includes: the second temperature is 150-370° C., e.g., 220-350° C., or 300-330° C.; the time is 0.05-0.5h, e.g., 0.1-0.2h; the vacuum degree is 50-300 mmHg, e.g., 50-150 mmHg; preferably, the heating rate from the first temperature up to the second temperature is 50-200° C./min, e.g., 50-150° C./min. Optionally, the dehydrated and dechlorinated waste plastic particles obtained by the comminution treatment have a particle diameter of 100-2000 μm.

Optionally, the preliminary melting-liquefaction-dechlorination unit for waste plastics includes a second screw-type heating transportation equipment and a vacuum device communicated with the second screw-type heating transportation equipment. Preferably, the second screw-type heating transportation equipment is a twin screw-type or single screw-type transportation equipment. Preferably, the condition of the heat melting-dechlorination treatment includes: the feeding rate is 5-5000 kg/h, e.g., 100-4000 kg/h; the outlet temperature is 150-370° C., e.g., 300-330° C., the reaction time is 0.1-0.5h, e.g., 0.1-0.3h; the vacuum degree of the preliminary melting-liquefaction-dechlorination unit for waste plastic is 50-300 mmHg, e.g., 50-150 mmHg. Preferably, the dechlorinated waste plastic particles obtained with the comminution treatment have a particle diameter of 100-2000 μm.

Optionally, the waste plastic to be treated includes one or more of LDPE, HDPE, PS, PP, PET and PVC; optionally, the chlorine content of the waste plastic to be treated is less than 10 wt % and/or the PVC content of the waste plastic to be treated is less than 10 wt %; the ash content of the waste plastic to be treated is 1-40 wt %, e.g., 3-30 wt % or 3-20 wt %.

The fluidized cracking processing method of waste plastics disclosed in the present disclosure can realize the effective utilization of waste plastics and increase gasoline production. The generated coke is in-situ gasified to provide the heat required for the cracking reaction and can effectively remove impurities in the product.

The second aspect of the present disclosure provides a processing system for fluidized cracking of waste plastics, the system comprises: a liquefaction unit for waste plastics, a viscosity reduction unit for waste plastics, a contact-cracking reaction unit, a separation unit and a regeneration unit;
the liquefaction unit for waste plastics comprises an inlet for the waste plastic to be treated and an outlet for liquefied waste plastic, and the liquefaction unit for waste plastic is configured to liquefy the waste plastic to be treated;
the viscosity reduction unit for waste plastics includes an inlet for liquefied waste plastics, an outlet for liquefied waste plastic oil and an outlet for a first dry gas, the viscosity reduction unit for waste plastic is configured to perform viscosity reduction treatment on the liquefied waste plastics;
the contact-cracking reaction unit includes an inlet for cracking raw material, an inlet for contact agent, an outlet for reaction product and an outlet for spent contact agent; the inlet for cracking raw material is communicated with the outlet for liquefied waste plastic oil of the viscosity reduction unit for waste plastics, the contact-cracking reaction unit is configured to perform a cracking reaction treatment on the liquefied waste plastic oil;
the separation unit includes a separation inlet, an outlet for a second dry gas, an outlet for liquefied gas, an outlet for gasoline fraction, an outlet for diesel fraction and an outlet for gas oil fraction; the separation inlet is communicated with the outlet for reaction product of the contact-cracking reaction unit, the separation unit is configured to perform a separation treatment on the reaction product;
the regeneration unit includes an inlet for spent contact agent, an inlet for oxygen-containing gas, an outlet for regenerated contact agent and an outlet for regeneration flue gas; the regeneration unit is configured to regenerate the spent contact agent in the presence of oxygen gas to produce a regenerated contact agent and a regeneration flue gas; the outlet for regenerated contact agent is communicated with the inlet for contact agent of the contact-cracking reaction unit.

Preferably, the viscosity reduction unit for waste plastics further comprises at least one viscosity reduction reactor, the viscosity reduction reactor provides the inlet for liquefied waste plastics, the outlet for liquefied waste plastic oil and the outlet for a first dry gas of the viscosity reduction unit for waste plastics; preferably, the viscosity reduction reactor is an adiabatic reactor. Preferably, the viscosity reduction reactor is provided with a temperature-control and heating device so that it can be achieved that the temperature of the material sent to the reactor does not change significantly. Herein “the temperature of the material sent to the reactor does not significantly change” means that the temperature is maintained within a range of 90%-110%, e.g. 92%-108%, or 95%-105%, or 98%-102% of the temperature of the material sent to the reactor (for example, the temperature of the material sent to the reactor can be represented by the reactor outlet temperature).

Optionally, the processing system further comprises a heat melting-dehydration-dechlorination unit for waste plastics, a cooling and comminution unit and a hydrogen chloride absorption unit;
the heat melting-dehydration-dechlorination unit for waste plastics includes an inlet for chlorine-containing waste plastic raw material, an outlet for dehydrated and dechlorinated waste plastic and an outlet for hydrogen chloride-containing gas; the heat melting-dehydration-dechlorination unit for waste plastic is configured to perform the melting-dehydration treatment and dechlorination treatment on chlorine-containing waste plastic raw material;
the cooling and comminution unit is configured to perform the cooling treatment and comminution treatment on the dehydrated and dechlorinated waste plastic from the heat melting-dehydration-dechlorination unit for waste plastics;
the hydrogen chloride absorption unit includes an inlet for hydrogen chloride-containing gas phase material and an inlet for hydrogen chloride absorbent; the inlet for hydrogen chloride-containing gas phase material is communicated with the outlet for hydrogen chloride-containing gas of the heat melting-dehydration-dechlorination unit for waste plastics;
preferably, the regeneration unit further comprises an inlet for dry gas, the inlet for dry gas is communicated with the outlet for a first dry gas of the viscosity reduction unit for waste plastics and/or the outlet for a second dry gas of the separation unit;
optionally, a connecting pipeline between the inlet for cracking raw material of the contact-cracking reaction unit and the outlet for liquefied waste plastic oil of the viscosity reduction unit for waste plastic is provided with a steam inlet;
preferably, the liquefaction unit for waste plastics includes a heating liquefaction transportation equipment, preferably, a quick heating liquefaction transportation equipment; optionally, the heating liquefaction transportation equipment include a first screw-type heating transportation equipment; preferably, the first screw-type heating transportation equipment is a twin screw-type or single screw-type heating transportation equipment with heating;
preferably, the heat melting-dehydration-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment.

Through the above-mentioned technical solutions, the present disclosure provides a processing method and system for fluidized cracking of waste plastics, which performs the liquefaction treatment and the viscosity reduction treatment on waste plastics raw material, and can quickly liquefy the waste plastics and reduce the viscosity of the waste plastics; then, the waste plastics are contacted with a fluidized contact agent for cracking reaction, so that the waste plastics can be contacted in a liquid form with the high-temperature contact agent and quickly pyrolyzed, thereby reducing the residence time of the products, obtaining a more ideal product distribution, and removing heteroatoms in the waste plastics; by producing gas-phase and liquid-phase products through contact cracking, waste plastics can be recycled as green resources, and the spent contact agent can be regenerated and recycled; and the processing method can realize continuous waste plastic processing and improve processing efficiency; it has strong adaptability to waste plastic raw materials and does not require comminution and rinsing; waste plastics in landfills can be dehydrated, dechlorinated and reduced in situ, and subsequent cracking recovery can be processed in a centralized manner, which is easy to expand the production scale and reduce processing costs.

Another object of the present disclosure is to provide a processing method and system for viscosity reduction, pyrolysis and cracking of waste plastics, which can effectively realize the resource-based, large-scale and continuous utilization of waste plastics, increase oil and gas production, and reduce coke generation.

In order to achieve the above-mentioned object, a third aspect of the present disclosure provides a processing method for viscosity reduction, pyrolysis and cracking of waste plastics, the method comprises the following steps:
S1. the waste plastic to be treated is sent to a liquefaction unit for waste plastics for liquefaction treatment to produce a liquefied waste plastic;
S2. the liquefied waste plastic is sent to a viscosity reduction unit for waste plastics for a viscosity reduction treatment to produce a viscosity-reduced liquefied waste plastic oil;
S3. the viscosity-reduced liquefied waste plastic oil is sent to a material heating unit for heating treatment to obtain a high-temperature liquefied waste plastic;
S4. the high-temperature liquefied waste plastic is sent to a pyrolysis reaction unit for pyrolysis reaction to obtain a pyrolysis product and coke;
S5. the pyrolysis product is sent to a separation unit to perform a separation treatment to produce, for example, a dry gas, a liquefied gas, a gasoline fraction, a diesel fraction and a gas oil fraction; optionally, before step S1, the method further comprises: a chlorine-containing waste plastic raw material is sent to a preliminary melting-liquefaction-dechlorination unit for waste plastics to perform a heat melting-dechlorination treatment to produce a hydrogen chloride-containing gas phase material and a dechlorinated waste plastic material; the dechlorinated waste plastic material is sent to the liquefaction unit for waste plastics; or the dechlorinated waste plastic material is subjected to cooling treatment and comminution treatment successively to produce dechlorinated waste plastic particles; the dechlorinated waste plastic particles are sent to the liquefaction unit for waste plastics; or optionally, before step S1, the method further comprises: a chlorine-containing waste plastic raw material is fed into a heat melting-dehydration-dechlorination unit for waste plastics, and the chlorine-containing waste plastic raw material is subjected to melting-dehydration treatment at a first temperature condition to produce a dehydrated waste plastic; then the dehydrated waste plastic is heated to a second temperature for dechlorination treatment to produce a dehydrated and dechlorinated waste plastic and a hydrogen chloride-containing gas; the dehydrated and dechlorinated waste plastic is subjected to cooling treatment and comminution treatment successively in a cooling and comminution unit to produce dehydrated and dechlorinated waste plastic particles; the dehydrated and dechlorinated waste plastic particles are sent to the liquefaction unit for waste plastics; or the dehydrated and dechlorinated waste plastic is directly sent to the liquefaction unit for waste plastics.

Optionally, the method further comprises: the hydrogen chloride-containing gas phase material is sent to a hydrogen chloride absorption unit to contact a hydrogen chloride absorbent to perform a hydrogen chloride absorption treatment to produce a chlorine-containing absorbent and a dechlorinated dry gas; optionally, the hydrogen chloride-containing gas phase material is sent to the hydrogen chloride absorption unit under the action of a vacuum system; wherein the hydrogen chloride absorbent is water or an alkali solution with a pH value greater than 7; optionally, the alkali solution comprises one or more of a sodium hydroxide solution, a potassium hydroxide solution, a calcium hydroxide solution, a sodium bicarbonate solution, a sodium carbonate solution and an ammonia solution.

Optionally, the method further comprises: recycling at least a part of the gas oil fraction from the separation unit to the viscosity reduction unit for waste plastics for reprocessing; preferably, the weight ratio of the reprocessed gas oil fraction to the waste plastic to be treated is 0.2-5.0:1, e.g., 0.2-2:1; preferably, the fraction with a distillation range of 350° C. or higher obtained by separation with the separation unit is used as the gas oil fraction.

Optionally, in step S1, a heating liquefaction transportation equipment is used in the liquefaction unit for waste plastics, preferably, the liquefaction treatment is carried out in a quick heating liquefaction transportation equipment; optionally, the heating liquefaction transportation equipment include a first screw-type heating transportation equipment; preferably, the first screw-type heating transportation equipment is a twin screw-type or single screw-type heating transportation equipment with heating; preferably, the condition of the liquefaction treatment includes: an outlet temperature is 370-480° C., e.g. 380-480° C., 380-450° C. or 400-450° C.; a residence time is 5-30 min, e.g. 5-20 min, or 5-15 min. The feeding pressure of the heating liquefaction transportation equipment can be an ordinary pressure or a reduced pressure or an increased pressure. For example, the feeding pressure can be an ordinary pressure, or 0-0.6 MPa, e.g., 0.1-0.3 MPa. Unless otherwise specified, the pressure used herein is a gauge pressure. The pressure of the liquefaction treatment is the internal pressure of the heating liquefaction transportation equipment.

Optionally, in step S2, a viscosity reduction reactor is used in the viscosity reduction unit for waste plastics to perform the viscosity reduction treatment; preferably, the viscosity reduction reactor is an adiabatic reactor; preferably, the condition of the viscosity reduction treatment includes: the reaction temperature is 350-450° C., e.g. 370-450° C., 380-420° C., 350-400° C., 370-410° C., 390-450° C. or 390-420° C.; the residence time is 10-200 min, from an economic viewpoint, the residence time is not greater than 200 min, e.g. not greater than 180 min, the residence time is e.g. 10-180 min, 15-120 min, 20-120 min, 20-90 min, 30-120 min, 30-90 min, 50-90 min, 50-70 min, 20-60 min, or 30-70 min. The pressure of the viscosity reduction treatment is not particularly limited, and the viscosity reduction treatment may be performed under an ordinary pressure or a reduced pressure or an increased pressure. For example, the pressure of the viscosity reduction treatment can be an ordinary pressure, or 0-0.6 MPa, e.g., 0.1-0.3 MPa. Unless otherwise specified, the pressure used herein is a gauge pressure.

When the viscosity reduction treatment is carried out in the viscosity reduction reactor, the material sent to the reactor is cracked, so that the viscosity is further reduced. The viscosity reduction reactor can ensure that the temperature of the material sent to the reactor does not significantly change. Since the cracking is endothermic, additional heat is required, if necessary, to ensure that the temperature of the material sent to the reactor does not significantly change. Therefore, in a preferred embodiment, the viscosity reduction reactor is provided with a temperature-control and heating device so that it can be achieved that the temperature of the material sent to the reactor does not change significantly. Herein “the temperature of the material sent to the reactor does not significantly change” means that the temperature is maintained within a range of 90%-110%, e.g. 92%-108%, or 95%-105%, or 98%-102% of the temperature of the material sent to the reactor (for example, the temperature of the material sent to the reactor can be represented by the reactor outlet temperature). The condition of the viscosity reduction treatment can allow the material leaving the reactor after the viscosity reduction treatment to have a viscosity of less than 12000 cP@200° C., e.g. 5000-10000 cP@200° C., 6000-9000 cP@200° C., 100-12000 cP@200° C., 100-2000 cP@200° C., 100-1500 cP@200° C., 100-1000 cP@200° C., 100-500 cP@200° C. The viscosity is measured using a rotational viscometer according to SY/T 0520-2008.

Optionally, in step S3, the material heating unit includes a heating furnace; preferably, the condition of the heating treatment includes: the furnace outlet temperature is 450° C.-550° C., e.g., 460° C.-520° C.; the steam injection amount is 0.5-5 wt %, e.g., 1-3 wt %.

Optionally, in step S4, the condition of the pyrolysis reaction includes: the pyrolysis column top pressure is 0.05-0.6 MPa, e.g., 0.1-0.3 MPa; the pyrolysis reaction temperature is 450-520° C., e.g., 480-520° C. Unless otherwise specified, the pressure used herein is a gauge pressure.

Optionally, the preliminary melting-liquefaction-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment; preferably, the condition of the heat melting-dechlorination treatment includes: the feeding rate is 5-5000 kg/h, e.g., 100-4000 kg/h; the outlet temperature is 150-370° C., e.g., 300-330° C., the reaction time is 0.1-0.5h, e.g., 0.1-0.3 h; the vacuum degree of the preliminary melting-liquefaction-dechlorination unit for waste plastic is 50-300 mmHg, e.g., 50-150 mmHg; preferably, the dechlorinated waste plastic particles obtained with the comminution treatment have a particle diameter of 100-2000 μm.

Optionally, the heat melting-dehydration-dechlorination unit for waste plastics includes a second screw-type heating transportation equipment and a vacuum device communicated with the second screw-type heating transportation equipment. Preferably, the second screw-type heating transportation equipment is a twin screw-type or single screw-type transportation equipment. Preferably, the condition of the melting-dehydration treatment includes: the first temperature is 100-170° C., e.g., 120-150° C.; the time is 0.05-1 h, e.g., 0.05-0.5 h; the feeding rate of the chlorine-containing waste plastic raw material is 5-5000 kg/h, e.g., 100-4000 kg/h. Preferably, the condition of the dechlorination treatment includes: the second temperature is 150-370° C., e.g., 220-350° C., or 300-330° C.; the time is 0.05-0.5h, e.g., 0.1-0.2 h; the vacuum degree is 50-300 mmHg, e.g., 50-150 mmHg; preferably, the heating rate from the first temperature up to the second temperature is 50-200° C./min, e.g., 50-150° C./min. Optionally, the dehydrated and dechlorinated waste plastic particles obtained by the comminution treatment have a particle diameter of 100-2000 μm.

Optionally, the waste plastic to be treated includes one or more of LDPE, HDPE, PS, PP, PET and PVC; optionally, the PVC content of the waste plastic to be treated is less than 10 wt % and/or the chlorine content of the waste plastic to be treated is less than 10 wt %; the ash content of the waste plastic to be treated is 1-40 wt %, e.g., 3-30 wt % or 3-20 wt %.

The fourth aspect of the present disclosure provides a processing system for viscosity reduction, pyrolysis and cracking of waste plastics, the processing system comprises: a liquefaction unit for waste plastics, a viscosity reduction unit for waste plastics, a material heating unit, a pyrolysis reaction unit and a separation unit;
the liquefaction unit for waste plastics comprises an inlet for the waste plastic to be treated and an outlet for liquefied waste plastic, and the liquefaction unit for waste plastic is configured to liquefy the waste plastic to be treated;
the viscosity reduction unit for waste plastics includes an inlet for liquefied waste plastics and an outlet for liquefied waste plastic oil, the viscosity reduction unit for waste plastic is configured to perform viscosity reduction treatment on the liquefied waste plastics;
the material heating unit includes a heating inlet and a heating outlet, the heating inlet is communicated with the outlet for liquefied waste plastic oil of the viscosity reduction unit for waste plastics, the heating unit is configured to heat the viscosity-reduced liquefied waste plastic oil;
the pyrolysis reaction unit includes an inlet for pyrolysis reactant and an outlet for pyrolysis product, the inlet for pyrolysis reactant is communicated with the heating outlet of the heating unit, the pyrolysis reaction unit is configured to perform the pyrolysis reaction treatment on the high-temperature liquefied waste plastics;
the separation unit includes a separation inlet, an outlet for dry gas, an outlet for liquefied gas, an outlet for gasoline fraction, an outlet for diesel fraction and an outlet for gas oil fraction; the separation inlet is communicated with the outlet for pyrolysis product of the pyrolysis reaction unit, the separation unit is configured to perform the separation treatment on the pyrolysis product.

Preferably, the viscosity reduction unit for waste plastics further comprises at least one viscosity reduction reactor, the viscosity reduction reactor provides an inlet for liquefied waste plastics and an outlet for liquefied waste plastic oil of the viscosity reduction unit for waste plastics; preferably, the viscosity reduction reactor is an adiabatic reactor. Preferably, the viscosity reduction reactor is provided with a temperature-control and heating device so that it can be achieved that the temperature of the material sent to the reactor does not change significantly. Herein “the temperature of the material sent to the reactor does not significantly change” means that the temperature is maintained within a range of 90%-110%, e.g. 92%-108%, or 95%-105%, or 98%-102% of the temperature of the material sent to the reactor (for example, the temperature of the material sent to the reactor can be represented by the reactor outlet temperature).

Optionally, the system further includes a preliminary melting-liquefaction-dechlorination unit for waste plastics and a hydrogen chloride absorption unit;
the preliminary melting-liquefaction-dechlorination unit for waste plastics includes an inlet for chlorine-containing waste plastic raw material, an outlet for hydrogen chloride-containing gas phase material, and an outlet for dechlorinated waste plastics liquid phase material,
the preliminary melting-liquefaction-dechlorination unit for waste plastic is configured to perform the heat melting-dechlorination treatment on chlorine-containing waste plastic raw material; the outlet for dechlorinated waste plastics liquid phase material is communicated with the inlet for the waste plastic to be treated of the liquefaction unit for waste plastics.

The hydrogen chloride absorption unit includes an inlet for hydrogen chloride-containing gas phase material, an inlet for hydrogen chloride absorbent and an outlet for dechlorinated dry gas; the inlet for hydrogen chloride-containing gas phase material is communicated with the outlet for hydrogen chloride-containing gas phase material of the preliminary melting-liquefaction-dechlorination unit for waste plastics;

Preferably, the liquefaction unit for waste plastics includes a heating liquefaction transportation equipment, preferably, a quick heating liquefaction transportation equipment; optionally, the heating liquefaction transportation equipment include a first screw-type heating transportation equipment; preferably, the first screw-type heating transportation equipment is a twin screw-type or single screw-type heating transportation equipment with heating.

Preferably, the preliminary melting-liquefaction-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment.

Preferably, the viscosity reduction unit for waste plastics further comprises an inlet for cycle oil; the inlet for cycle oil is communicated with the outlet for gas oil fraction of the separation unit.

Optionally, the preliminary melting-liquefaction-dechlorination unit for waste plastics further comprises an outlet for non-condensing gas.

Through the above-mentioned technical solutions, the present disclosure provides a processing method and system for viscosity reduction, pyrolysis and cracking of waste plastics. According to the present disclosure, the waste plastics to be treated is subjected to a quick liquefaction treatment and viscosity reduction treatment, thereby reducing the viscosity of the liquefied waste plastics without coking and excessive cracking, thereby forming uniform and fluidized waste plastics that can be transported by a pump; then the waste plastics are treated with a heating furnace or the like to quickly reach the pyrolysis reaction temperature, and the high-temperature liquefied waste plastics are transported to a pyrolysis column for pyrolysis reaction, thereby realizing the resource utilization of the waste plastics and reducing the generation of coke; through the processing method of the present disclosure, the waste plastics in the landfill can be dehydrated, dechlorinated and reduced in situ, and the subsequent cracking and recovery can be processed in a centralized manner, which is easy to expand the production scale and reduce the processing cost; the process flow is simple, and the equipment investment is relatively small, so that the waste plastics can be recycled in a large-scale, continuous and green resource manner.

In summary, the present invention overcomes the difficulties of waste plastic recycling in the prior art by the following means, thereby completing the present invention: (1) rapidly heating waste plastic containing polyvinyl chloride to decompose it, and using a vacuum method to rapidly separate the decomposed HCl from the reactor, thereby improving the dechlorination efficiency; (2) by strong squeezing and stirring to increase the heating area, the waste plastic is quickly heated until it becomes a flowable liquid, and the viscosity is reduced so that it can be transported by a pump. When the waste plastic is quickly liquefied, the thermal conductivity of the liquid is greatly increased, and a heating furnace or other heating equipment can be used to pyrolyze the liquid waste plastic, thereby obtaining a higher liquid yield and a lower coking rate; (3) after the waste plastics are liquefied, the transportation density of the raw materials is greatly increased compared with that of solid waste plastics. Therefore, it is possible to not only scale up the processing of waste plastics but also realize the continuous pyrolysis recovery of waste plastics.

Other features and advantages of the present disclosure will be described in detail in the subsequent detailed description.

### DESCRIPTION OF THE DRAWINGS

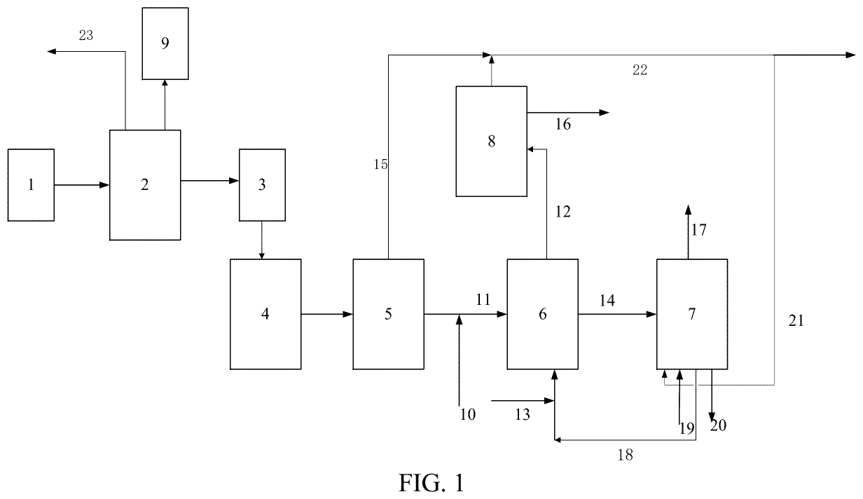

The accompanying drawings are intended to provide a further understanding of the present disclosure and form a part of the specification. They are used together with the specific embodiments below to explain the present invention but do not constitute a limitation on the present invention. In the figures: FIG. 1 is an exemplary flow chart of a processing method and system for fluidized cracking of waste plastics provided in the present disclosure, wherein
1—waste plastic storage tank, 2—heat melting-dehydration-dechlorination-comminution unit for waste plastics, 3—dehydrated and dechlorinated waste plastic particles storage tank, 4—liquefaction unit for waste plastics, 5—viscosity reduction unit for waste plastics, 6—contact-cracking reaction unit, 7—regeneration unit, 8—separation unit, 9—hydrogen chloride absorption unit, 10—pipeline, 11—pipeline, 12—pipeline, 13—pipeline, 14—pipeline, 15—pipeline, 16—pipeline, 17—pipeline, 18—pipeline, 19—pipeline, 20—pipeline, 21—pipeline, 22—pipeline, 23—pipeline;

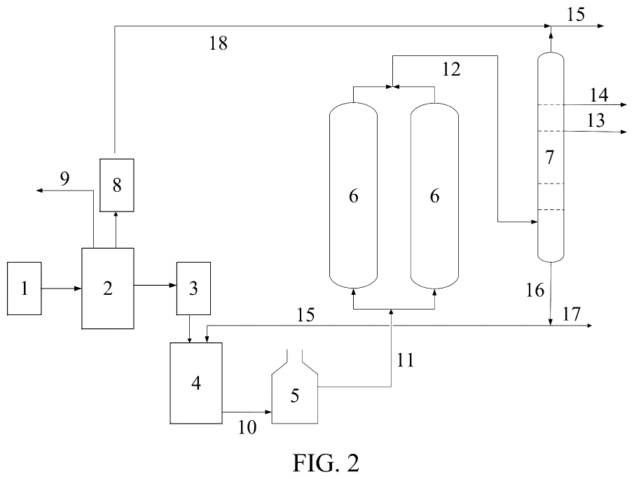

FIG. 2 is an exemplary flow chart of a processing method and system for viscosity reduction, pyrolysis and cracking of waste plastics provided in the present disclosure, wherein
1—waste plastic storage tank, 2—preliminary melting-liquefaction-dechlorination unit for waste plastics, 3—quick heating liquefaction transportation equipment, 4—adiabatic viscosity reduction reactor, 5—heating furnace, 6—pyrolysis reaction unit, 7—separation unit, 8—hydrogen chloride absorption unit, 9—pipeline, 10—pipeline, 11—pipeline, 12—pipeline, 13—pipeline, 14—pipeline, 15—pipeline, 16—pipeline, 17—pipeline, 18—pipeline.

### DETAILED DESCRIPTION

The following provides a detailed explanation of specific embodiments of this disclosure. It should be understood that the specific embodiments described herein are only intended to illustrate and explain the present invention, and are not intended to limit the present invention.

The term “plastic(s)” described in the present invention includes waste plastics and fresh plastics, wherein “fresh plastic(s)” refers to fresh polymers formed by polymerization of polymerization monomers constituting plastics, usually in the form of particles. Fresh polymers or fresh plastics can be processed into various plastic products. These plastic products themselves can be used as “waste plastic(s)” of the present invention. Usually, these plastic products will be discarded after use and can be used as “waste plastic(s)” of the present invention. In addition, the discarded plastic products can be converted into “new” plastic products after recycling and reuse, and the waste formed by these new plastic products can also be used as “waste plastic(s)” of the present invention. Recycling and reuse can be carried out for one, two or more generations, and these “new” plastic products of each generation and the waste formed by them can be used as “waste plastic(s)” of the present invention. Fresh polymers and fresh plastics can also be used as “waste plastic(s)” of the present invention. Therefore, within the scope of the present invention, “plastic(s)” and “waste plastic(s)” can be considered as synonyms.

In the present invention, the plastic or waste plastic is preferably derived from a thermoplastic plastic. In a preferred embodiment, the plastic of the present invention is mainly composed of C and H, that is, the sum of the mass of the C and H elements of the plastic accounts for 50% or more of the total mass of the plastic, such as 60% or more; the upper limit can be 100%. In a preferred embodiment, the number average molecular weight of the plastic can be 1,000-2,000,000, for example, 2,000-300,000, or 5,000-100,000. In a preferred embodiment, the N content of the plastic is 10% or less by weight, e.g. 5% or less, 4% or less, 3% or less, 2% or less, or 1% or less; the lower limit can be 0%, for example, the lower limit is 0.0001%, 0.001%, or 0.01%. In a preferred embodiment, the S content of the plastic is 1% or less by weight, e.g. 0.5% or less, 0.4% or less, 0.3% or less, 0.2% or less, or 0.1% or less; the lower limit can be 0%, for example, the lower limit is 0.00001%, 0.001%, or 0.001%. For example, examples of polymers constituting plastics include, but are not limited to, polyethylene (PE) such as low-density polyethylene (LDPE) and high-density polyethylene (HDPE), polystyrene (PS), polypropylene (PP), polyethylene terephthalate (PET) and polyvinyl chloride (PVC).

According to the first aspect of the present disclosure, a processing method for fluidized cracking of waste plastic is provided. Referring to FIG. 1, the method comprises the following steps:
S1. the waste plastic to be treated is sent to a liquefaction unit for waste plastics for liquefaction treatment to produce a liquefied waste plastic;
S2. the liquefied waste plastic is sent to a viscosity reduction unit for waste plastics for a viscosity reduction treatment to produce a viscosity-reduced liquefied waste plastic oil and a first dry gas;
S3. the viscosity-reduced liquefied waste plastic oil is sent to a contact-cracking reaction unit, and contacted with a contact agent in a fluidized state to perform a cracking reaction to produce a reaction product and a spent contact agent;
S4. the reaction product is sent to a separation unit to perform a separation treatment to produce, for example, a second dry gas, a liquefied gas, a gasoline fraction, a diesel fraction and a gas oil fraction; the spent contact agent is sent to a regeneration unit, and the spent contact agent is regenerated in the presence of oxygen gas to produce a regenerated contact agent and a regeneration flue gas; and the regenerated contact agent is returned to the contact-cracking reaction unit for continuous use.

The present disclosure provides a processing method and system for fluidized cracking of waste plastics, which performs the liquefaction treatment and the viscosity reduction treatment on waste plastics raw material, and can quickly liquefy the waste plastics and reduce the viscosity of the waste plastics; then, the waste plastics are contacted with a fluidized contact agent for cracking reaction, so that the waste plastics can be contacted in a liquid form with the high-temperature contact agent and quickly pyrolyzed, thereby reducing the residence time of the products, obtaining a more ideal product distribution, and removing heteroatoms in the waste plastics; by producing gas-phase and liquid-phase products through contact cracking, waste plastics can be recycled as green resources, and the spent contact agent can be regenerated and recycled; and the processing method can realize continuous waste plastic processing and improve processing efficiency; it has strong adaptability to waste plastic raw materials and does not require comminution and rinsing; waste plastics in landfills can be dehydrated, dechlorinated and reduced in situ, and subsequent cracking recovery can be processed in a centralized manner, which is easy to expand the production scale and reduce processing costs.

In a specific embodiment, the waste plastic to be treated includes one or more of low-density polyethylene (LDPE), high-density polyethylene (HDPE), polystyrene (PS), polypropylene (PP), polyethylene terephthalate (PET) and polyvinyl chloride (PVC); optionally, the chlorine element content in the waste plastics to be treated is less than 10 wt %; and/or the PVC content of the waste plastic to be treated is less than 10 wt %; the ash content of the waste plastic to be treated is 1-40 wt %, e.g., 3-30 wt %, or 3-20 wt %. Waste plastics in landfills can be directly used as the waste plastic raw materials in the present disclosure.

In a preferred embodiment, the heat melting-dehydration-dechlorination-comminution unit for waste plastics includes a heat melting-dehydration-dechlorination unit for waste plastics and a cooling and comminution unit.

Referring to FIG. 1, before step S1, the method further includes:
a chlorine-containing waste plastic raw material is fed into a heat melting-dehydration-dechlorination unit for waste plastics of a heat melting-dehydration-dechlorination-comminution unit for waste plastics, and the chlorine-containing waste plastic raw material is subjected to melting-dehydration treatment at a first temperature condition to produce a dehydrated waste plastic; then the dehydrated waste plastic is heated to a second temperature for dechlorination treatment to produce a dehydrated and dechlorinated waste plastic and a hydrogen chloride-containing gas;
the dehydrated and dechlorinated waste plastic is subjected to cooling treatment and comminution treatment successively in a cooling and comminution unit to produce dehydrated and dechlorinated waste plastic particles; the dehydrated and dechlorinated waste plastic particles are sent to the liquefaction unit for waste plastics; or the dehydrated and dechlorinated waste plastic is directly sent to the liquefaction unit for waste plastics.

In the present disclosure, in the step for heat melting-dehydration-dechlorination of waste plastics and in the step for liquefaction of waste plastics, a (quick) heating liquefaction transportation equipment can be shared, or each one (quick) heating liquefaction transportation equipment is used in each step; for example, a (quick) heating liquefaction transportation equipment is a screw-type heating transportation equipment (twin screw-type or single screw-type) with heating.

In a further embodiment, the method further comprises:
the hydrogen chloride-containing gas is sent to a hydrogen chloride absorption unit to contact a hydrogen chloride absorbent to perform a hydrogen chloride absorption treatment; optionally, the hydrogen chloride-containing gas is sent to a hydrogen chloride absorption unit under the action of a vacuum system.

The present invention adopts a heat melting-dehydration-dechlorination-comminution unit for waste plastics and a hydrogen chloride absorption unit, so that the chlorine in the waste plastic PVC is decomposed in the gas phase, and a vacuum system is used to quickly separate HCl, so as to avoid the secondary reaction of HCl, improve the dechlorination efficiency of the waste plastic, and reduce the anti-corrosion burden of subsequent equipment.

In a specific embodiment, the hydrogen chloride absorbent is water or an alkali solution with a pH value greater than 7; optionally, the alkali solution comprises one or more of a sodium hydroxide solution, a potassium hydroxide solution, a calcium hydroxide solution, a sodium bicarbonate solution, a sodium carbonate solution and an ammonia solution.

In a preferred embodiment, referring to FIG. 1, the method further comprises: the cracking reaction carried out in the contact-cracking reaction unit in step S3 also produces an ash with charcoal; the method further comprises: the ash with charcoal and a spent contact agent are sent to a regeneration unit, and in the presence of oxygen gas, the spent contact agent and the charcoal of the ash with charcoal are subjected to a complete combustion reaction to produce a regeneration flue gas and a regenerated contact agent. The processing method provided by the present disclosure can regenerate the charcoal-containing spent contact agent through a complete combustion reaction, thereby realizing the recycling of the contact agent.

In a preferred embodiment, referring to FIG. 1, the method further comprises:
at least a part of a first dry gas and/or at least a part of a second dry gas are sent to the regeneration unit, and in the presence of oxygen gas and dry gas, the spent contact agent and the ash with charcoal are subjected to a complete combustion reaction to produce a regeneration flue gas and a regenerated contact agent;
preferably, based on the total weight of the spent contact agent, the spent contact agent has a charcoal content of 0.5-5.0 wt %.

According to the present disclosure, a dry gas generated in the processing procedure of waste plastic is used to regenerate the spent contact agent, thereby improving resource utilization efficiency and contact agent regeneration efficiency.

In a specific embodiment, when the regeneration flue gas reaches the emission standard, the regeneration flue gas is discharged; wherein the regeneration flue gas emission standard is a conventional standard in the art, for example, referring to GB13271-2014 standard.

In an embodiment, in step S1, a heating liquefaction transportation equipment is used in the liquefaction unit for waste plastics, preferably, the liquefaction treatment is carried out in a quick heating liquefaction transportation equipment; optionally, the heating liquefaction transportation equipment include a first screw-type heating transportation equipment; preferably, the first screw-type heating transportation equipment is a twin screw-type or single screw-type heating transportation equipment with heating.

In a preferred embodiment, the condition of the liquefaction treatment includes: an outlet temperature is 370-480° C., e.g. 380-480° C., 380-450° C. or 400-450° C.; a residence time is 5-30 min, e.g. 5-20 min, or 5-15 min. The feeding pressure of the heating liquefaction transportation equipment can be an ordinary pressure or a reduced pressure or an increased pressure. For example, the feeding pressure can be an ordinary pressure, or 0-0.6 MPa, e.g., 0.1-0.3 MPa. Unless otherwise specified, the pressure used herein is a gauge pressure. The pressure of the liquefaction treatment is the internal pressure of the heating liquefaction transportation equipment.

In an embodiment, in step S2, a viscosity reduction reactor is used in the viscosity reduction unit for waste plastics to perform the viscosity reduction treatment; preferably, the viscosity reduction reactor is an adiabatic reactor. The adiabatic viscosity reduction reactor in the present disclosure can be any reactor known in the art, e.g. an upflow viscosity reduction reactor or a downflow viscosity reduction reactor.

In a preferred embodiment, the condition of the viscosity reduction treatment includes: the reaction temperature is 350-450° C., e.g. 370-450° C., 380-420° C., 350-400° C., 370-410° C., 390-450° C. or 390-420° C.; the residence time is 10-200 min, from an economic viewpoint, the residence time is not greater than 200 min, e.g. not greater than 180 min, the residence time is e.g. 10-180 min, 15-120 min, 20-120 min, 20-90 min, 30-120 min, 30-90 min, 50-90 min, 50-70 min, 20-60 min, or 30-70 min.

The pressure of the viscosity reduction treatment is not particularly limited, and the viscosity reduction treatment may be performed under an ordinary pressure or a reduced pressure or an increased pressure. For example, the pressure of the viscosity reduction treatment can be an ordinary pressure, or 0-0.6 MPa, e.g., 0.1-0.3 MPa. Unless otherwise specified, the pressure used herein is a gauge pressure.

The viscosity reduction reactor can ensure that the temperature of the material sent to the reactor does not significantly change. Since the cracking is endothermic, additional heat is required, if necessary, to ensure that the temperature of the material sent to the reactor does not significantly change. In a preferred embodiment, the viscosity reduction reactor is provided with a temperature-control and heating device so that it can be achieved that the temperature of the material sent to the reactor does not change significantly. Herein “the temperature of the material sent to the reactor does not significantly change” means that the temperature is maintained within a range of 90%-110%, e.g. 92%-108%, or 95%-105%, or 98%-102% of the temperature of the material sent to the reactor (for example, the temperature of the material sent to the reactor can be represented by the reactor outlet temperature). The viscosity reduction treatment can allow the material leaving the reactor after the viscosity reduction treatment to have a viscosity of less than 12000 cP@200° C., preferably less than 5000 cP@200° C., e.g. 100-4000 cP@200° C., 100-3000 cP@200° C., 100-2000 cP@200° C., 100-1000 cP@200° C., 200-1500 cP@200° C., 200-1000 cP@200° C. The viscosity is measured using a rotational viscometer according to SY/T 0520-2008. In an embodiment, in step S3, the condition of the cracking reaction includes: the reaction temperature is 500-750° C., the weight hourly space velocity is 1-100 h⁻¹, the mass ratio of the contact agent to the waste plastic to be treated is 5-30:1. In the present disclosure, the cracking reaction is carried out in a fluidized bed reactor, which has a conventional structure in the art.

In a preferred embodiment, in step S3, the condition of the cracking reaction includes: the reaction temperature is 490-750° C., the weight hourly space velocity is 1-100h⁻¹, the mass ratio of the contact agent to the waste plastic to be treated is 6-20:1.

The pressure of the cracking reaction is not particularly limited, and the cracking reaction may be performed under an ordinary pressure or a reduced pressure or an increased pressure. For example, the pressure of the cracking reaction can be an ordinary pressure, or 0-0.6 MPa, e.g., 0.1-0.3 MPa. Unless otherwise specified, the pressure used herein is a gauge pressure.

In a preferred embodiment, the method further comprises: the viscosity-reduced liquefied waste plastic oil and steam are sent to the contact-cracking reaction unit; preferably, the mass ratio of steam to the waste plastic to be treated is 0.05-1:1, e.g., 0.1-0.5:1.

In an embodiment, in step S3, the contact agent is one or more of silica/alumina material catalyst, quartz sand or coal tar powder; preferably, the contact agent has a particle size of 20-3000 μm.

Optionally, the silica/alumina material is selected from a molecular sieve-containing catalyst and/or a molecular sieve-free catalyst; preferably, the molecular sieve-containing catalyst is one or more of a catalyst containing one or more molecular sieves of X molecular sieve, Y molecular sieve, mordenite, ZSM-5, pillared clay molecular sieve, and SAPO, and a waste FCC catalyst;
preferably, the molecular sieve-free catalyst is a catalyst prepared with one or more of a first Raw Material as raw material, wherein the first Raw Material includes amorphous silica-alumina, clay, kaolin, montmorillonite, rectorite, illite, chlorite, pseudo-boehmite and silica; or
the molecular sieve-free catalyst is a catalyst prepared from one or more of a second Raw Material treated by acid washing, calcining and sieving as raw material, the second Raw Material includes amorphous silica-alumina, clay, kaolin, montmorillonite, rectorite, illite and chlorite; or a catalyst prepared from one or more of the second Raw Material treated by acid washing, calcining and sieving and pseudo-boehmite and/or silica as raw material;
optionally, the coal coke powder is coal powder and/or petroleum coke powder.

In an embodiment, the regeneration is carried out in a dense-phase fluidized bed regenerator; preferably, the regeneration condition includes: the residence time of an introduced gas (air) is 0.5-60s, preferably 1.0-10s, the dense bed has a gasification temperature of 600-750° C., e.g., 600-700° C., the introduced gas is a gas having an oxygen gas content of 10-50 vol %, the dense bed has a linear velocity of 0.05-0.6 m/s, e.g., 0.2-0.4 m/s. The dense-phase fluidized bed regenerator in the present disclosure adopts a device conventionally selected in the art. The pressure of the regeneration treatment is not particularly limited, and the regeneration treatment may be performed under an ordinary pressure or a reduced pressure or an increased pressure. For example, the pressure of the regeneration treatment can be an ordinary pressure, or 0-0.6 MPa, e.g., 0.1-0.3 MPa. Unless otherwise specified, the pressure used herein is a gauge pressure.

In an embodiment, the heat melting-dehydration-dechlorination unit of the heat melting-dehydration-dechlorination-comminution unit for waste plastics includes a second screw-type heating transportation equipment and a vacuum device communicated with the second screw-type heating transportation equipment; preferably, the second screw-type heating transportation equipment is a twin screw-type or single screw-type transportation equipment.

In a preferred embodiment, the condition of the melting-dehydration treatment includes: the first temperature is 100-170° C., e.g., 120-150° C.; the time is 0.05-1 h, e.g., 0.05-0.5 h; the feeding rate of the chlorine-containing waste plastic raw material is 5-5000 kg/h, e.g., 100-4000 kg/h; preferably, the heating rate of the melting-dehydration treatment is 30-200° C./min, e.g., 50-100° C./min.

The pressure of the melting-dehydration treatment is not particularly limited, and the melting-dehydration treatment may be performed under an ordinary pressure or a reduced pressure or an increased pressure. For example, the pressure of the melting-dehydration treatment can be an ordinary pressure, or 0-0.6 MPa, e.g., 0.1-0.3 MPa. Unless otherwise specified, the pressure used herein is a gauge pressure.

Preferably, the condition of the dechlorination treatment includes: the second temperature is 150-370° C., e.g., 220-350° C., or 300-330° C.; the time is 0.05-0.5h, e.g., 0.1-0.2 h; the vacuum degree is 50-300 mmHg, e.g., 50-150 mmHg; preferably, the heating rate from the first temperature up to the second temperature is 50-200° C./min, e.g., 50-150° C./min. In the present disclosure, a gradual heating method can be adopted, first heating to the first temperature for melting-dehydration treatment, and then heating to the second temperature for dechlorination treatment, so as to improve the dehydration and dechlorination effect of waste plastics.

The pressure of the dechlorination treatment is not particularly limited, and the dechlorination treatment may be performed under an ordinary pressure or a reduced pressure or an increased pressure. For example, the pressure of the dechlorination treatment can be an ordinary pressure, or 0-0.6 MPa, e.g., 0.1-0.3 MPa. Unless otherwise specified, the pressure used herein is a gauge pressure.

In a specific embodiment, the dehydrated and dechlorinated waste plastic particles obtained by the comminution treatment have a particle diameter of 100-2000 μm.

In the present disclosure, the device and method for cooling treatment and comminution treatment may be conventional device and method in the art.

The second aspect of the present disclosure provides a processing system for fluidized cracking of waste plastics, the system comprises: a liquefaction unit for waste plastics, a viscosity reduction unit for waste plastics, a contact-cracking reaction unit, a separation unit and a regeneration unit;
the liquefaction unit for waste plastics comprises an inlet for the waste plastic to be treated and an outlet for liquefied waste plastic, and the liquefaction unit for waste plastic is configured to liquefy the waste plastic to be treated;
the viscosity reduction unit for waste plastics includes an inlet for liquefied waste plastics, an outlet for liquefied waste plastic oil and an outlet for a first dry gas, the viscosity reduction unit for waste plastic is configured to perform viscosity reduction treatment on the liquefied waste plastics;
the contact-cracking reaction unit includes an inlet for cracking raw material, an inlet for contact agent, an outlet for reaction product and an outlet for spent contact agent; the inlet for cracking raw material is communicated with the outlet for liquefied waste plastic oil of the viscosity reduction unit for waste plastics, the contact-cracking reaction unit is configured to perform a cracking reaction treatment on the liquefied waste plastic oil;
the separation unit includes a separation inlet, an outlet for a second dry gas, an outlet for liquefied gas, an outlet for gasoline fraction, an outlet for diesel fraction and an outlet for gas oil fraction; the separation inlet is communicated with the outlet for reaction product of the contact-cracking reaction unit, the separation unit is configured to perform a separation treatment on the reaction product; the regeneration unit includes an inlet for spent contact agent, an inlet for oxygen-containing gas, an outlet for regenerated contact agent and an outlet for regeneration flue gas; the regeneration unit is configured to regenerate the spent contact agent in the presence of oxygen gas to produce a regenerated contact agent and a regeneration flue gas; the outlet for regenerated contact agent is communicated with the inlet for contact agent of the contact-cracking reaction unit.

In a preferred embodiment, the viscosity reduction unit for waste plastics further comprises at least one viscosity reduction reactor, the viscosity reduction reactor provides the inlet for liquefied waste plastics, the outlet for liquefied waste plastic oil and the outlet for a first dry gas of the viscosity reduction unit for waste plastics; preferably, the viscosity reduction reactor is an adiabatic reactor. Preferably, the viscosity reduction reactor is provided with a temperature-control and heating device so that it can be achieved that the temperature of the material sent to the reactor does not change significantly. Herein “the temperature of the material sent to the reactor does not significantly change” means that the temperature is maintained within a range of 90%-110%, e.g. 92%-108%, or 95%-105%, or 98%-102% of the temperature of the material sent to the reactor (for example, the temperature of the material sent to the reactor can be represented by the reactor outlet temperature).

In a preferred embodiment, a connecting pipeline between the inlet for cracking raw material of the contact-cracking reaction unit and the outlet for liquefied waste plastic oil of the viscosity reduction unit for waste plastic is also provided with a steam inlet to facilitate the atomization of the liquefied waste plastic oil.

In a preferred embodiment, the regeneration unit further comprise an inlet for dry gas, the inlet for dry gas is communicated with the outlet for a first dry gas of the viscosity reduction unit for waste plastics and/or the outlet for a second dry gas of the separation unit.

In an embodiment, the processing system further comprises a heat melting-dehydration-dechlorination unit for waste plastics, a cooling and comminution unit and a hydrogen chloride absorption unit;
the heat melting-dehydration-dechlorination unit for waste plastics includes an inlet for chlorine-containing waste plastic raw material, an outlet for dehydrated and dechlorinated waste plastic and an outlet for hydrogen chloride-containing gas; the heat melting-dehydration-dechlorination unit for waste plastic is configured to perform the melting-dehydration treatment and dechlorination treatment on chlorine-containing waste plastic raw material;
the cooling and comminution unit is configured to perform the cooling treatment and comminution treatment on the dehydrated and dechlorinated waste plastic from the heat melting-dehydration-dechlorination unit for waste plastics;
the hydrogen chloride absorption unit includes an inlet for hydrogen chloride-containing gas phase material and a hydrogen chloride absorbent; the inlet for hydrogen chloride-containing gas phase material is communicated with the outlet for hydrogen chloride-containing gas of the heat melting-dehydration-dechlorination unit for waste plastics.

In a specific embodiment, the liquefaction unit for waste plastics includes a heating liquefaction transportation equipment, preferably, a quick heating liquefaction transportation equipment; optionally, the heating liquefaction transportation equipment includes a first screw-type heating transportation equipment; preferably, the first screw-type heating transportation equipment is a twin screw-type or single screw-type heating transportation equipment with heating;
the heat melting-dehydration-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment.

In a preferred embodiment, the heat melting-dehydration-dechlorination unit for waste plastics and the liquefaction unit for waste plastics share a heating liquefaction transportation equipment, including a first screw-type heating transportation equipment, and the middle part of the screw-type heating transportation equipment is provided with a gas outlet communicated with a vacuum device.

In a specific embodiment, the heat melting-dehydration-dechlorination-comminution unit for waste plastics also includes an outlet for non-condensing gas to leading out the non-condensing gas.

In a specific embodiment, referring to FIG. 1, a processing system for fluidized cracking of waste plastics includes: liquefaction unit for waste plastics, viscosity reduction unit for waste plastics, contact-cracking reaction unit, separation unit, heat melting-dehydration-dechlorination unit for waste plastics, cooling and comminution unit, hydrogen chloride absorption unit and regeneration unit;
wherein the heat melting-dehydration-dechlorination unit for waste plastics includes an inlet for chlorine-containing waste plastic raw material, an outlet for dehydrated and dechlorinated waste plastic and an outlet for hydrogen chloride-containing gas; the heat melting-dehydration-dechlorination unit for waste plastic is configured to perform the melting-dehydration treatment and dechlorination treatment on chlorine-containing waste plastic raw material;
the cooling and comminution unit is configured to perform the cooling treatment and comminution treatment on the dehydrated and dechlorinated waste plastic from the heat melting-dehydration-dechlorination unit for waste plastics;
the liquefaction unit for waste plastics includes an inlet for the waste plastic to be treated and an outlet for liquefied waste plastic, the liquefaction unit for waste plastic is configured to liquefy the waste plastic to be treated; wherein the waste plastic to be treated can be dehydrated and dechlorinated waste plastic particles from the cooling and comminution unit, or the dehydrated and dechlorinated waste plastic from the heat melting-dehydration-dechlorination unit for waste plastics;
the viscosity reduction unit for waste plastics includes an inlet for liquefied waste plastics, an outlet for liquefied waste plastic oil and an outlet for a first dry gas, the viscosity reduction unit for waste plastic is configured to perform viscosity reduction treatment on the liquefied waste plastics;
the contact-cracking reaction unit includes an inlet for cracking raw material, an inlet for contact agent, an outlet for reaction product and an outlet for spent contact agent; the inlet for cracking raw material is communicated with the outlet for liquefied waste plastic oil of the viscosity reduction unit for waste plastics, the contact-cracking reaction unit is configured to perform a cracking reaction treatment on the liquefied waste plastic oil; a connecting pipeline between the inlet for cracking raw material of the contact-cracking reaction unit and the outlet for liquefied waste plastic oil of the viscosity reduction unit for waste plastic is provided with a steam inlet;
the separation unit includes a separation inlet, an outlet for a second dry gas, an outlet for liquefied gas, an outlet for gasoline fraction, an outlet for diesel fraction and an outlet for gas oil fraction; the separation inlet is communicated with the outlet for reaction product of the contact-cracking reaction unit, the separation unit is configured to perform a separation treatment on the reaction product;
the hydrogen chloride absorption unit includes an inlet for hydrogen chloride-containing gas phase material and a hydrogen chloride absorbent; the inlet for hydrogen chloride-containing gas phase material is communicated with the outlet for hydrogen chloride-containing gas of the heat melting-dehydration-dechlorination unit for waste plastics;
the regeneration unit includes an inlet for spent contact agent, an inlet for oxygen-containing gas, an outlet for regenerative agent and an outlet for flue gas; the inlet for spent contact agent is communicated with the outlet for spent contact agent of the contact-cracking reaction unit, the outlet for regenerative agent is communicated with the inlet for contact agent of the contact-cracking reaction unit; preferably, the regeneration unit further comprise an inlet for dry gas, the inlet for dry gas is communicated with the outlet for a first dry gas of the viscosity reduction unit for waste plastics and/or the outlet for a second dry gas of the separation unit.

The third aspect of the present disclosure provides a processing method for viscosity reduction, pyrolysis and cracking of waste plastics, the method comprises the following steps:
S1. the waste plastic to be treated is sent to a liquefaction unit for waste plastics for liquefaction treatment to produce a liquefied waste plastic;
S2. the liquefied waste plastic is sent to a viscosity reduction unit for waste plastics for a viscosity reduction treatment to produce a viscosity-reduced liquefied waste plastic oil;
S3. the viscosity-reduced liquefied waste plastic oil is sent to a material heating unit for heating treatment to obtain a high-temperature liquefied waste plastic;
S4. the high-temperature liquefied waste plastic is sent to a pyrolysis reaction unit for pyrolysis reaction to obtain a pyrolysis product and coke;
S5. the pyrolysis product is sent to a separation unit to perform a separation treatment to produce, for example, a dry gas, a liquefied gas, a gasoline fraction, a diesel fraction and a gas oil fraction.

The present disclosure provides a processing method for viscosity reduction, pyrolysis and cracking of waste plastics. The waste plastics to be treated is subjected to a liquefaction treatment and viscosity reduction treatment, thereby reducing the viscosity of the liquefied waste plastics; then the waste plastics are heated to reach the pyrolysis reaction temperature and form a uniform stream with good fluidity; the high-temperature liquefied waste plastics are subjected to a pyrolysis reaction, realizing the resource utilization of the waste plastics and reducing the generation of coke; through the processing method of the present disclosure, the waste plastics in the landfill can be dehydrated, dechlorinated and reduced in situ, and the subsequent cracking and recovery can be processed in a centralized manner, which is easy to expand the production scale and reduce the processing cost; the process flow is simple, and the equipment investment is relatively small, so that the waste plastics can be recycled in a green resource manner.

In a specific embodiment, the waste plastic to be treated includes one or more of low-density polyethylene (LDPE), high-density polyethylene (HDPE), polystyrene (PS), polypropylene (PP), polyethylene terephthalate (PET) and polyvinyl chloride (PVC); optionally, the chlorine element content in the waste plastics to be treated is less than 10 wt %; and/or the PVC content of the waste plastic to be treated is less than 10 wt %; the ash content of the waste plastic to be treated is 1-40 wt %, e.g., 3-30 wt %, or 3-20 wt %. Waste plastics in landfills can be directly used as the waste plastic raw materials in the present disclosure.

In a preferred embodiment, before step S1, the method further comprises:
a chlorine-containing waste plastic raw material is sent to a preliminary melting-liquefaction-dechlorination unit for waste plastics to perform a heat melting-dechlorination treatment to produce a hydrogen chloride-containing gas phase material and a dechlorinated waste plastic material;
the dechlorinated waste plastic material is sent to the liquefaction unit for waste plastics; or
the dechlorinated waste plastic material is subjected to cooling treatment and comminution treatment successively to produce dechlorinated waste plastic particles; the dechlorinated waste plastic particles are sent to the liquefaction unit for waste plastics.

In the present disclosure, in the step for heat melting-dechlorination and in the step for liquefaction of waste plastics, a (quick) heating liquefaction transportation equipment can be shared, or each one (quick) heating liquefaction transportation equipment is used in each step; for example, a (quick) heating liquefaction transportation equipment is a screw-type heating transportation equipment (twin screw-type or single screw-type) with heating.

In an embodiment, the method further comprises:
the hydrogen chloride-containing gas is sent to a hydrogen chloride absorption unit to contact a hydrogen chloride absorbent to perform a hydrogen chloride absorption treatment to produce a chlorine-containing absorbent and a dechlorinated dry gas;
optionally, the hydrogen chloride-containing gas is sent to a hydrogen chloride absorption unit under the action of a vacuum system.

The present invention adopts a preliminary melting-liquefaction-dechlorination unit for waste plastics, so that the chlorine in the waste plastic PVC is decomposed in the gas phase, and a vacuum system is used to quickly separate HCl, so as to avoid the secondary reaction of HCl, improve the dechlorination efficiency of the waste plastic, and reduce the anti-corrosion burden of subsequent equipment.

In a specific embodiment, the hydrogen chloride absorbent is water or an alkali solution with a pH value greater than 7; optionally, the alkali solution comprises one or more of a sodium hydroxide solution, a potassium hydroxide solution, a calcium hydroxide solution, a sodium bicarbonate solution, a sodium carbonate solution and an ammonia solution.

In a preferred embodiment, the method further comprises: recycling at least a part of the gas oil fraction from the separation unit to the viscosity reduction unit for waste plastics for reprocessing; preferably, the fraction with a distillation range of 350° C. or higher obtained by separation with the separation unit is used as the gas oil fraction. Introducing the gas oil fraction into the viscosity reduction unit for waste plastics can not only further improve the efficiency of waste plastic resource utilization, but also facilitate the viscosity reduction treatment of waste plastics. In a specific embodiment, the weight ratio of the gas oil fraction to be reprocessed to the waste plastic to be treated is 0.2-5.0:1, preferably 0.2-2:1.

In an embodiment, in step S1, a heating liquefaction transportation equipment is used in the liquefaction unit for waste plastics, preferably, the liquefaction treatment is carried out in a quick heating liquefaction transportation equipment; optionally, the heating liquefaction transportation equipment includes a first screw-type heating transportation equipment; preferably, the first screw-type heating transportation equipment is a twin screw-type or single screw-type heating transportation equipment with heating. The quick heating liquefaction transportation equipment adopted in the present invention is conducive to the quick liquefaction treatment of solid waste plastics.

In a preferred embodiment, the condition of the liquefaction treatment includes: an outlet temperature is 370-480° C., e.g. 380-480° C., 380-450° C. or 400-450° C.; a residence time is 5-30 min, e.g. 5-20 min, or 5-15 min. The feeding pressure of the heating liquefaction transportation equipment can be an ordinary pressure or a reduced pressure or an increased pressure. For example, the feeding pressure can be an ordinary pressure, or 0-0.6 MPa, e.g., 0.1-0.3 MPa. Unless otherwise specified, the pressure used herein is a gauge pressure. The pressure of the liquefaction treatment is the internal pressure of the heating liquefaction transportation equipment.

In an embodiment, in step S2, a viscosity reduction reactor, e.g., an adiabatic viscosity reduction reactor is used in the viscosity reduction unit for waste plastics to perform the viscosity reduction treatment. The viscosity reduction reactor in the present disclosure can be any reactor known in the art, e.g. an upflow viscosity reduction reactor or a downflow viscosity reduction reactor.

In a preferred embodiment, the condition of the viscosity reduction treatment includes: the reaction temperature is 350-450° C., e.g. 370-450° C., 380-420° C., 350-400° C., 370-410° C., 390-450° C. or 390-420° C.; the residence time is 10-200 min, from an economic viewpoint, the residence time is not greater than 200 min, e.g. not greater than 180 min, the residence time is e.g. 10-180 min, 15-120 min, 20-120 min, 20-90 min, 30-120 min, 30-90 min, 50-90 min, 50-70 min, 20-60 min, or 30-70 min.

The pressure of the viscosity reduction treatment is not particularly limited, and the viscosity reduction treatment may be performed under an ordinary pressure or a reduced pressure or an increased pressure. For example, the pressure of the viscosity reduction treatment can be an ordinary pressure, or 0-0.6 MPa, e.g., 0.1-0.3 MPa. Unless otherwise specified, the pressure used herein is a gauge pressure.

The viscosity reduction reactor can ensure that the temperature of the material sent to the reactor does not significantly change. Since the cracking is endothermic, additional heat is required, if necessary, to ensure that the temperature of the material sent to the reactor does not significantly change. In a preferred embodiment, the viscosity reduction reactor is provided with a temperature-control and heating device so that it can be achieved that the temperature of the material sent to the reactor does not change significantly. Herein “the temperature of the material sent to the reactor does not significantly change” means that the temperature is maintained within a range of 90%-110%, e.g. 92%-108%, or 95%-105%, or 98%-102% of the temperature of the material sent to the reactor (for example, the temperature of the material sent to the reactor can be represented by the reactor outlet temperature). The viscosity reduction treatment can allow the material leaving the reactor after the viscosity reduction treatment to have a viscosity of less than 12000 cP@200° C., e.g. 5000-10000 cP@200° C., 6000-9000 cP@200° C., 100-12000 cP@200° C., 100-2000 cP@200° C., 100-1500 cP@200° C., 100-1000 cP@200° C., 100-500 cP@200° C. The viscosity is measured using a rotational viscometer according to SY/T 0520-2008.

In an embodiment, in step S3, the material heating unit includes a heating furnace; preferably, the condition of the heating treatment includes: the furnace outlet temperature is 450° C.-550° C., e.g., 460° C.-520° C.; the steam injection amount is 0.5-5 wt %, preferably 1-3 wt %.

In an embodiment, in step S4, the condition of the pyrolysis reaction includes: the pyrolysis column top pressure is 0.05-0.6 MPa, e.g., 0.1-0.3 MPa; the pyrolysis reaction temperature is 450-520° C., e.g., 480-520° C.

In the present disclosure, the pyrolysis reaction unit may include a plurality of pyrolysis columns arranged in parallel.

In an embodiment, the preliminary melting-liquefaction-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment.

In a preferred embodiment, the condition of the heat melting-dechlorination treatment includes: the feeding rate is 5-5000 kg/h, e.g., 100-4000 kg/h; the outlet temperature is 150-370° C., e.g., 300-330° C., the reaction time is 0.1-0.5h, e.g., 0.1-0.3h; the vacuum degree of the preliminary melting-liquefaction-dechlorination unit for waste plastic is 50-300 mmHg, e.g., 50-150 mmHg.

Preferably, the dechlorinated waste plastic particles obtained with the comminution treatment have a particle diameter of 100-2000 μm.

In the present disclosure, the device and method for cooling treatment and comminution treatment may be conventional device and method in the art.

The fourth aspect of the present disclosure provides a processing system for viscosity reduction, pyrolysis and cracking of waste plastics, referring to FIG. 2, the processing system comprises: a liquefaction unit for waste plastics, a viscosity reduction unit for waste plastics, a material heating unit, a pyrolysis reaction unit and a separation unit;
the liquefaction unit for waste plastics comprises an inlet for the waste plastic to be treated and an outlet for liquefied waste plastic, and the liquefaction unit for waste plastic is configured to liquefy the waste plastic to be treated;
the viscosity reduction unit for waste plastics includes an inlet for liquefied waste plastics and an outlet for liquefied waste plastic oil, the viscosity reduction unit for waste plastic is configured to perform viscosity reduction treatment on the liquefied waste plastics;
the material heating unit includes a heating inlet and a heating outlet, the heating inlet is communicated with the outlet for liquefied waste plastic oil of the viscosity reduction unit for waste plastics, the heating unit is configured to heat the viscosity-reduced liquefied waste plastic oil;
the pyrolysis reaction unit includes an inlet for pyrolysis reactant and an outlet for pyrolysis product, the inlet for pyrolysis reactant is communicated with the heating outlet of the heating unit, the pyrolysis reaction unit is configured to perform the pyrolysis reaction treatment on the high-temperature liquefied waste plastics;
the separation unit includes a separation inlet, an outlet for dry gas, an outlet for liquefied gas, an outlet for gasoline fraction, an outlet for diesel fraction and an outlet for gas oil fraction; the separation inlet is communicated with the outlet for pyrolysis product of the pyrolysis reaction unit, the separation unit is configured to perform the separation treatment on the pyrolysis product.

In a preferred embodiment, the viscosity reduction unit for waste plastics further comprises at least one viscosity reduction reactor, the viscosity reduction reactor provides an inlet for liquefied waste plastics and an outlet for liquefied waste plastic oil of the viscosity reduction unit for waste plastics; preferably, the viscosity reduction reactor is an adiabatic reactor. Preferably, the viscosity reduction reactor is provided with a temperature-control and heating device so that it can be achieved that the temperature of the material sent to the reactor does not change significantly. Herein “the temperature of the material sent to the reactor does not significantly change” means that the temperature is maintained within a range of 90%-110%, e.g. 92%-108%, or 95%-105%, or 98%-102% of the temperature of the material sent to the reactor (for example, the temperature of the material sent to the reactor can be represented by the reactor outlet temperature).

In a preferred embodiment, the viscosity reduction unit for waste plastics further comprises an inlet for cycle oil; the inlet for cycle oil is communicated with the outlet for gas oil fraction of the separation unit.

In an embodiment, referring to FIG. 2, the system further includes a preliminary melting-liquefaction-dechlorination unit for waste plastics and a hydrogen chloride absorption unit;
the preliminary melting-liquefaction-dechlorination unit for waste plastics includes an inlet for chlorine-containing waste plastic raw material, an outlet for hydrogen chloride-containing gas phase material and an outlet for dechlorinated waste plastics liquid phase material, the preliminary melting-liquefaction-dechlorination unit for waste plastic is configured to perform the heat melting-dechlorination treatment on chlorine-containing waste plastic raw material; the outlet for dechlorinated waste plastics liquid phase material is communicated with the inlet for the waste plastic to be treated of liquefaction unit for waste plastics;
the hydrogen chloride absorption unit includes an inlet for hydrogen chloride-containing gas phase material, a hydrogen chloride absorbent and an outlet for dechlorinated dry gas; the inlet for hydrogen chloride-containing gas phase material is communicated with the outlet for hydrogen chloride-containing gas phase material of the preliminary melting-liquefaction-dechlorination unit for waste plastics.

In a specific embodiment, the liquefaction unit for waste plastics includes a heating liquefaction transportation equipment, preferably, a quick heating liquefaction transportation equipment; optionally, the heating liquefaction transportation equipment includes a first screw-type heating transportation equipment; preferably, the first screw-type heating transportation equipment is a twin screw-type or single screw-type heating transportation equipment with heating;
the preliminary melting-liquefaction-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment.

In a preferred embodiment, the preliminary melting-liquefaction-dechlorination unit for waste plastics and the liquefaction unit for waste plastics share a heating liquefaction transportation equipment, including a first screw-type heating transportation equipment, and the middle part of the screw-type heating transportation equipment is provided with a gas outlet communicated with a vacuum device.

In a specific embodiment, the preliminary melting-liquefaction-dechlorination unit for waste plastics also includes an outlet for non-condensing gas to leading out the non-condensing gas.

In a specific embodiment, referring to FIG. 2, the system includes: preliminary melting-liquefaction-dechlorination unit for waste plastics, hydrogen chloride absorption unit, liquefaction unit for waste plastics, viscosity reduction unit for waste plastics, material heating unit, pyrolysis reaction unit and separation unit;
wherein the liquefaction unit for waste plastics includes an inlet for the waste plastic to be treated and an outlet for liquefied waste plastic, the liquefaction unit for waste plastic is configured to liquefy the waste plastic to be treated;
the viscosity reduction unit for waste plastics includes an inlet for liquefied waste plastics, an inlet for cycle oil and an outlet for liquefied waste plastic oil, the viscosity reduction unit for waste plastic is configured to perform viscosity reduction treatment on the liquefied waste plastics;
the material heating unit includes a heating inlet and a heating outlet, the heating inlet is communicated with the outlet for liquefied waste plastic oil of the viscosity reduction unit for waste plastics, the heating unit is configured to heat the viscosity-reduced liquefied waste plastic oil;
the pyrolysis reaction unit includes an inlet for pyrolysis reactant and an outlet for pyrolysis product, the inlet for pyrolysis reactant is communicated with the heating outlet of the heating unit, the pyrolysis reaction unit is configured to perform the pyrolysis reaction treatment on the high-temperature liquefied waste plastics;
the separation unit includes a separation inlet, an outlet for dry gas, an outlet for liquefied gas, an outlet for gasoline fraction, an outlet for diesel fraction and an outlet for gas oil fraction; the separation inlet is communicated with the outlet for pyrolysis product of the pyrolysis reaction unit, the separation unit is configured to perform the separation treatment on the pyrolysis product; the outlet for gas oil fraction of the separation unit is communicated with the inlet for cycle oil of the viscosity reduction unit for waste plastics;
the preliminary melting-liquefaction-dechlorination unit for waste plastics includes an inlet for chlorine-containing waste plastic raw material, an outlet for hydrogen chloride-containing gas phase material and an outlet for dechlorinated waste plastics liquid phase material, the preliminary melting-liquefaction-dechlorination unit for waste plastic is configured to perform the heat melting-dechlorination treatment on chlorine-containing waste plastic raw material; the outlet for dechlorinated waste plastics liquid phase material is communicated with the inlet for the waste plastic to be treated of liquefaction unit for waste plastics;
the hydrogen chloride absorption unit includes an inlet for hydrogen chloride-containing gas phase material, a hydrogen chloride absorbent and an outlet for dechlorinated dry gas; the inlet for hydrogen chloride-containing gas phase material is communicated with the outlet for hydrogen chloride-containing gas phase material of the preliminary melting-liquefaction-dechlorination unit for waste plastics.

The present disclosure also provides the following two sets of technical solutions A and B.

A1. A method for processing waste plastics by fluidized cracking, characterized in that the method comprises the following steps:
S1. the waste plastic to be treated is sent to a liquefaction unit for waste plastics for liquefaction treatment to produce a liquefied waste plastic;
S2. the liquefied waste plastic is sent to a viscosity reduction unit for waste plastics for a viscosity reduction and cracking treatment to produce a viscosity-reduced and cracked liquefied waste plastic oil and a first dry gas;
S3. the viscosity-reduced and cracked liquefied waste plastic oil is sent to a contact-cracking reaction unit, and contacted with a contact agent in a fluidized state to perform a cracking reaction to produce a reaction product and a spent contact agent;
S4. the reaction product is sent to a separation unit to perform a separation treatment to produce a second dry gas, a liquefied gas, a gasoline fraction, a diesel fraction and a gas oil fraction;
the spent contact agent is sent to a regeneration unit, and the spent contact agent is regenerated in the presence of oxygen gas to produce a regenerated contact agent and a regeneration flue gas; and the regenerated contact agent is returned to the contact-cracking reaction unit for continuous use.

A2. the processing method according to technical solution A1, characterized in that before step S1, the method further comprises:
a chlorine-containing waste plastic raw material is introduced into the heat melting-dehydration-dechlorination unit for waste plastics, and the chlorine-containing waste plastic raw material is subjected to a melting-dehydration treatment under a first temperature condition to obtain a dehydrated waste plastic; then the dehydrated waste plastic is heated to a second temperature for dechlorination treatment to obtain a dehydrated and dechlorinated waste plastic and a hydrogen chloride-containing gas;
the dehydrated and dechlorinated waste plastic is subjected to cooling treatment and comminution treatment successively in a cooling and comminution unit to produce dehydrated and dechlorinated waste plastic particles; the dehydrated and dechlorinated waste plastic particles are sent to the liquefaction unit for waste plastics; or
the dehydrated and dechlorinated waste plastic is directly sent to the liquefaction unit for waste plastics.

A3. The processing method according to technical solution A2, characterized in that the method further comprises:
the hydrogen chloride-containing gas is sent to a hydrogen chloride absorption unit and contacts with a hydrogen chloride absorbent to perform a hydrogen chloride absorption treatment; optionally, the hydrogen chloride-containing gas is sent to the hydrogen chloride absorption unit under the action of a vacuum system;
wherein the hydrogen chloride absorbent is water or an alkali solution with a pH value greater than 7; optionally, the alkali solution comprises one or more of a sodium hydroxide solution, a potassium hydroxide solution, a calcium hydroxide solution, a sodium bicarbonate solution, a sodium carbonate solution and an ammonia solution.

A4. The processing method according to technical solution A1, characterized in that in step S3, a cracking reaction is performed in the contact-cracking reaction unit to further produce an ash with charcoal;
the method further includes: the ash with charcoal and a spent contact agent are sent to a regeneration unit, and in the presence of oxygen gas, the spent contact agent and the charcoal of the ash with charcoal are subjected to a complete combustion reaction to produce a regeneration flue gas and a regenerated contact agent;
preferably, the method further comprises:
at least a part of a first dry gas and/or at least a part of a second dry gas are sent to the regeneration unit, and in the presence of oxygen gas and dry gas, the spent contact agent and the ash with charcoal are subjected to a complete combustion reaction to produce a regeneration flue gas and a regenerated contact agent;
preferably, based on the total weight of the contact agent to be regenerated, the charcoal content of the contact agent to be regenerated is 0.5-5.0 wt %.

A5. The processing method according to technical solution A1, characterized in that in step S1, the liquefaction unit for waste plastics adopts a heating liquefaction transportation equipment to perform the liquefaction treatment; optionally, the heating liquefaction transportation equipment include a first screw-type heating transportation equipment; preferably, the first screw-type heating transportation equipment is a twin screw-type or single screw-type heating transportation equipment with heating;
preferably, the condition of the liquefaction treatment includes: the outlet temperature is 380-500° C., preferably 400-450° C.; the residence time is 5-30 min, preferably 5-15 min.

A6. The processing method according to technical solution A1, characterized in that in step S2, the viscosity reduction unit for waste plastics adopts a viscosity reduction reactor to perform the viscosity reduction and cracking treatment; preferably, the viscosity reduction reactor is an adiabatic viscosity reduction reactor;
preferably, the condition of the viscosity reduction and cracking treatment includes: the reaction temperature is 380-500° C., preferably 390-450° C., further preferably 390-420° C.; the residence time is 10-90 min, preferably 20-70 min, further preferably 30-70 min.

A7. The processing method according to technical solution A1, characterized in that in step S3, the condition of the cracking reaction includes: the reaction temperature is 490-750° C., the weight hourly space velocity is 1-100h⁻¹, the mass ratio of the contact agent to the waste plastic to be treated is 5-30:1; preferably, the reaction temperature is 500-650° C., the weight hourly space velocity is 3-60h⁻¹, the mass ratio of the contact agent to the waste plastic to be treated is 6-20:1;
preferably, the viscosity reduced and cracked liquefied waste plastic oil and steam are sent to the contact-cracking reaction unit; preferably, the mass ratio of steam to the waste plastic to be treated is 0.05-1:1, preferably 0.1-0.5:1.

A8. The processing method according to technical solution A1, characterized in that In step S3, the contact agent is one or more of silica/alumina material catalyst, quartz sand or coal tar powder; preferably, the contact agent has a particle size of 20-3000 μm;
optionally, the silica/alumina material is selected from a molecular sieve-containing catalyst and/or a molecular sieve-free catalyst; preferably, the molecular sieve-containing catalyst is one or more of a catalyst containing one or more molecular sieves of X molecular sieve, Y molecular sieve, mordenite, ZSM-5, pillared clay molecular sieve, and SAPO, and a waste FCC catalyst;
preferably, the molecular sieve-free catalyst is a catalyst prepared with one or more of a first Raw Material as raw material, wherein the first Raw Material includes amorphous silica-alumina, clay, kaolin, montmorillonite, rectorite, illite, chlorite, pseudo-boehmite and silica; or
the molecular sieve-free catalyst is a catalyst prepared from one or more of a second Raw Material treated by acid washing, calcining and sieving as raw material, the second Raw Material includes amorphous silica-alumina, clay, kaolin, montmorillonite, rectorite, illite and chlorite; or a catalyst prepared from one or more of the second Raw Material treated by acid washing, calcining and sieving and pseudo-boehmite and/or silica as raw material;
optionally, the coal coke powder is coal powder and/or petroleum coke powder.

A9. The processing method according to technical solution A4, characterized in that the regeneration is carried out in a dense-phase fluidized bed regenerator; preferably, the regeneration condition includes: the residence time of an introduced gas (air) is 0.5-60s, preferably 1.0-10s, the dense bed has a gasification temperature of 600-750° C., preferably 600-700° C., the introduced gas is a gas having an oxygen gas content of 10-50 vol %, the dense bed has a linear velocity of 0.05-0.6 m/s, preferably 0.2-0.4 m/s.

A10. The processing method according to technical solution A2, characterized in that the heat melting-dehydration-dechlorination unit of the heat melting-dehydration-dechlorination-comminution unit for waste plastics includes a second screw-type heating transportation equipment and a vacuum device communicated with the second screw-type heating transportation equipment; preferably, the second screw-type heating transportation equipment is a twin screw-type or single screw-type transportation equipment;
preferably, the condition of the melting-dehydration treatment includes: the first temperature is 100-170° C., preferably 120-150° C.; the time is 0.05-1 h, preferably 0.05-0.5h; the feeding rate of the chlorine-containing waste plastic raw material is 5-5000 kg/h, preferably 100-4000 kg/h;
preferably, the condition of the dechlorination treatment includes: the second temperature is 150-370° C., preferably 220-350° C., further preferably 300-330° C.; the time is 0.05-0.5h, preferably 0.1-0.2h; the vacuum degree is 50-300 mmHg, preferably 50-150 mmHg;
preferably, the heating rate from the first temperature up to the second temperature is 50-200° C./min, preferably 50-150° C./min;
optionally, the dehydrated and dechlorinated waste plastic particles obtained by the comminution treatment have a particle diameter of 100-2000 μm.

A11. The processing method according to technical solution A1, characterized in that the waste plastic to be treated includes one or more of LDPE, HDPE, PS, PP, PET and PVC;
optionally, the chlorine content in the waste plastic to be treated is less than 10 wt %; the ash content in the waste plastic to be treated is 1-40 wt %, preferably 3-20 wt %.

A12. A processing system for fluidized cracking of waste plastics, characterized in that the system comprises: a liquefaction unit for waste plastics, a viscosity reduction unit for waste plastics, a contact-cracking reaction unit, a separation unit and a regeneration unit;
the liquefaction unit for waste plastics comprises an inlet for the waste plastic to be treated and an outlet for liquefied waste plastic, and the liquefaction unit for waste plastic is configured to liquefy the waste plastic to be treated;
the viscosity reduction unit for waste plastics includes an inlet for liquefied waste plastics, an outlet for liquefied waste plastic oil and an outlet for a first dry gas, the viscosity reduction unit for waste plastic is configured to perform the viscosity reduction and cracking treatment on the liquefied waste plastics;
the contact-cracking reaction unit includes an inlet for cracking raw material, an inlet for contact agent, an outlet for reaction product and an outlet for spent contact agent; the inlet for cracking raw material is communicated with the outlet for liquefied waste plastic oil of the viscosity reduction unit for waste plastics, the contact-cracking reaction unit is configured to perform a cracking reaction treatment on the liquefied waste plastic oil;
the separation unit includes a separation inlet, an outlet for a second dry gas, an outlet for liquefied gas, an outlet for gasoline fraction, an outlet for diesel fraction and an outlet for gas oil fraction; the separation inlet is communicated with the outlet for reaction product of the contact-cracking reaction unit, the separation unit is configured to perform a separation treatment on the reaction product;
the regeneration unit includes an inlet for spent contact agent, an inlet for oxygen-containing gas, an outlet for regenerated contact agent and an outlet for regeneration flue gas; the regeneration unit is configured to regenerate the spent contact agent in the presence of oxygen gas to produce a regenerated contact agent and a regeneration flue gas; the outlet for regenerated contact agent is communicated with the inlet for contact agent of the contact-cracking reaction unit.

A13. The processing system according to technical solution A12, characterized in that the processing system further comprises a heat melting-dehydration-dechlorination unit for waste plastics, a cooling and comminution unit and a hydrogen chloride absorption unit;
the heat melting-dehydration-dechlorination unit for waste plastics includes an inlet for chlorine-containing waste plastic raw material, an outlet for dehydrated and dechlorinated waste plastic and an outlet for hydrogen chloride-containing gas; the heat melting-dehydration-dechlorination unit for waste plastic is configured to perform the melting-dehydration treatment and dechlorination treatment on the chlorine-containing waste plastics;
the cooling and comminution unit is configured to perform the cooling treatment and comminution treatment on the dehydrated and dechlorinated waste plastic from the heat melting-dehydration-dechlorination unit for waste plastics;
the hydrogen chloride absorption unit includes an inlet for hydrogen chloride-containing gas phase material and a hydrogen chloride absorbent; the inlet for hydrogen chloride-containing gas phase material is communicated with the outlet for hydrogen chloride-containing gas of the heat melting-dehydration-dechlorination unit for waste plastics;
preferably, the regeneration unit further comprises an inlet for dry gas, the inlet for dry gas is communicated with the outlet for a first dry gas of the viscosity reduction unit for waste plastics and/or the outlet for a second dry gas of the separation unit;
optionally, a connecting pipeline between the inlet for cracking raw material of the contact-cracking reaction unit and the outlet for liquefied waste plastic oil of the viscosity reduction unit for waste plastic is provided with a steam inlet;
preferably, the liquefaction unit for waste plastics includes a heating liquefaction transportation equipment; optionally, the heating liquefaction transportation equipment include a first screw-type heating transportation equipment; preferably, the first screw-type heating transportation equipment is a twin screw-type heating transportation equipment with heating;
preferably, the heat melting-dehydration-dechlorination unit for waste plastics includes a second screw-type heating transportation equipment and a vacuum device communicated with the second screw-type heating transportation equipment; preferably, the second screw-type heating transportation equipment is a twin screw-type transportation equipment.

B1. A processing method for viscosity reduction, pyrolysis and cracking of waste plastics, characterized in that the method comprises the following steps:
S1. the waste plastic to be treated is sent to a liquefaction unit for waste plastics for liquefaction treatment to produce a liquefied waste plastic;
S2. the liquefied waste plastic is sent to a viscosity reduction unit for waste plastics for a viscosity reduction and cracking treatment to produce a viscosity-reduced and cracked liquefied waste plastic oil;
S3. the viscosity reduced and cracked liquefied waste plastic oil is sent to a material heating unit for heating treatment to obtain a high-temperature liquefied waste plastic;
S4. the high-temperature liquefied waste plastic is sent to a pyrolysis reaction unit for pyrolysis reaction to obtain a pyrolysis product and coke;
S5. the pyrolysis product is sent to a separation unit to perform a separation treatment to produce a dry gas, a liquefied gas, a gasoline fraction, a diesel fraction and a gas oil fraction.

B2. The processing method according to technical solution B1, characterized in that before step S1, the method further comprises:
a chlorine-containing waste plastic raw material is sent to a preliminary melting-liquefaction-dechlorination unit for waste plastics to perform a heat melting-dechlorination treatment to produce a hydrogen chloride-containing gas phase material and a dechlorinated waste plastic material;
the dechlorinated waste plastic material is sent to the liquefaction unit for waste plastics; or
the dechlorinated waste plastic material is subjected to cooling treatment and comminution treatment successively to produce dechlorinated waste plastic particles; the dechlorinated waste plastic particles are sent to the liquefaction unit for waste plastics.

B3. The processing method according to technical solution B2, characterized in that the method further comprises:
the hydrogen chloride-containing gas is sent to a hydrogen chloride absorption unit to contact a hydrogen chloride absorbent to perform a hydrogen chloride absorption treatment to produce a chlorine-containing absorbent and a dechlorinated dry gas;
optionally, the hydrogen chloride-containing gas is sent to the hydrogen chloride absorption unit under the action of a vacuum system;
wherein the hydrogen chloride absorbent is water or an alkali solution with a pH value greater than 7; optionally, the alkali solution comprises one or more of a sodium hydroxide solution, a potassium hydroxide solution, a calcium hydroxide solution, a sodium bicarbonate solution, a sodium carbonate solution and an ammonia solution.

B4. The processing method according to technical solution B1, characterized in that the method further comprises:
recycling at least a part of a gas oil fraction from the separation unit to the viscosity reduction unit for waste plastics for reprocessing;
preferably, the weight ratio of the gas oil fraction to be reprocessed to the waste plastic to be treated is 0.2-5.0:1, preferably 0.2-2:1;
preferably, a fraction with a distillation range of greater than 350° C. obtained by separation with the separation unit is used as the gas oil fraction.

B5. The processing method according to technical solution B1, characterized in that in step S1, the liquefaction unit for waste plastics adopts a quick heating liquefaction transportation equipment to perform the liquefaction treatment; optionally, the quick heating liquefaction transportation equipment includes a first screw-type heating transportation equipment; preferably, the first screw-type heating transportation equipment is a twin screw-type or single screw-type heating transportation equipment with heating;
preferably, the condition of the liquefaction treatment includes: the outlet temperature is 370-500° C., preferably 380-450° C.; the residence time is 5-20 min, preferably 5-15 min.

B6. The processing method according to technical solution B1, characterized in that in step S2, the viscosity reduction unit for waste plastics adopts a viscosity reduction reactor to perform a viscosity reduction and cracking treatment; preferably, the viscosity reduction reactor is an adiabatic viscosity reduction reactor;
preferably, the condition of the viscosity reduction and cracking treatment includes: the reaction temperature is 370-450° C., preferably 380-420° C., more preferably 390-420° C.; the residence time is 2-120 min, preferably 30-70 min.

B7. The processing method according to technical solution B1, characterized in that in step S3, the material heating unit includes a heating furnace;
preferably, the condition of the heating treatment includes: the furnace outlet temperature is 450° C.-550° C., preferably 460° C.-520° C.; optionally, the steam injection amount is 0.5-5 wt %, preferably 1-3 wt %.

B8. The processing method according to technical solution B1, characterized in that in step S4, the condition of the pyrolysis reaction includes: the pyrolysis column top pressure is 0.05-0.6 MPa, preferably 0.1-0.3 MPa; the pyrolysis reaction temperature is 450-520° C., preferably 480-520° C.

B9. The processing method according to technical solution B2, characterized in that the preliminary melting-liquefaction-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment;
the condition of the heat melting-dechlorination treatment includes: the feeding rate is 5-5000 kg/h, preferably 100-4000 kg/h; the outlet temperature is 150-370° C., preferably 300-330° C., the reaction time is 0.1-0.5h, preferably 0.1-0.3h; the vacuum degree of the preliminary melting-liquefaction-dechlorination unit for waste plastic is 50-300 mmHg, preferably 50-150 mmHg;
preferably, the dechlorinated waste plastic particles obtained with the comminution treatment have a particle diameter of 100-2000 μm.

B10. The processing method according to technical solution B1, characterized in that the waste plastic to be treated includes one or more of LDPE, HDPE, PS, PP, PET and PVC;
optionally, the content of PVC in the waste plastic to be treated is less than 10 wt %; the ash content in the waste plastic to be treated is 1-40 wt %, preferably 3-30 wt %.

B11. A processing system for viscosity reduction, pyrolysis and cracking of waste plastics, characterized in that the processing system comprises: a liquefaction unit for waste plastics, a viscosity reduction unit for waste plastics, a material heating unit, a pyrolysis reaction unit and a separation unit;
the liquefaction unit for waste plastics comprises an inlet for the waste plastic to be treated and an outlet for liquefied waste plastic, and the liquefaction unit for waste plastic is configured to liquefy the waste plastic to be treated;
the viscosity reduction unit for waste plastics includes an inlet for liquefied waste plastics and an outlet for liquefied waste plastic oil, the viscosity reduction unit for waste plastic is configured to perform the viscosity reduction and cracking treatment on the liquefied waste plastics;
the material heating unit includes a heating inlet and a heating outlet, the heating inlet is communicated with the outlet for liquefied waste plastic oil of the viscosity reduction unit for waste plastics, the heating unit is configured to heat the viscosity-reduced and cracked liquefied waste plastic oil;
the pyrolysis reaction unit includes an inlet for pyrolysis reactant and an outlet for pyrolysis product, the inlet for pyrolysis reactant is communicated with the heating outlet of the heating unit, the pyrolysis reaction unit is configured to perform the pyrolysis reaction treatment on the high-temperature liquefied waste plastics;
the separation unit includes a separation inlet, an outlet for dry gas, an outlet for liquefied gas, an outlet for gasoline fraction, an outlet for diesel fraction and an outlet for gas oil fraction; the separation inlet is communicated with the outlet for pyrolysis product of the pyrolysis reaction unit, the separation unit is configured to perform the separation treatment on the pyrolysis product.

B12. The processing system according to technical solution B11, characterized in that the system further comprises a preliminary melting-liquefaction-dechlorination unit for waste plastics and a hydrogen chloride absorption unit;
the preliminary melting-liquefaction-dechlorination unit for waste plastics includes an inlet for chlorine-containing waste plastic raw material, an outlet for hydrogen chloride-containing gas phase material and an outlet for dechlorinated waste plastics liquid phase material, the preliminary melting-liquefaction-dechlorination unit for waste plastic is configured to perform the heat melting-dechlorination treatment on chlorine-containing waste plastic raw material; the outlet for dechlorinated waste plastics liquid phase material is communicated with the inlet for the waste plastic to be treated of the liquefaction unit for waste plastics;
the hydrogen chloride absorption unit includes an inlet for hydrogen chloride-containing gas phase material, a hydrogen chloride absorbent and an outlet for dechlorinated dry gas; the inlet for hydrogen chloride-containing gas phase material is communicated with the outlet for hydrogen chloride-containing gas phase material of the preliminary melting-liquefaction-dechlorination unit for waste plastics;
preferably, the liquefaction unit for waste plastics includes a heating liquefaction transportation equipment; optionally, the heating liquefaction transportation equipment include a first screw-type heating transportation equipment; preferably, the first screw-type heating transportation equipment is a twin screw-type or single screw-type heating transportation equipment with heating;
preferably, the preliminary melting-liquefaction-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment;
preferably, the viscosity reduction unit for waste plastics further comprises an inlet for cycle oil; the inlet for cycle oil is communicated with the outlet for gas oil fraction of the separation unit;
optionally, the preliminary melting-liquefaction-dechlorination unit for waste plastics further comprises an outlet for non-condensing gas.

The processing method and system of the present invention are further described below in conjunction with the accompanying drawings.

As shown in FIG. 1, the waste plastic raw materials stored in the waste plastic storage tank 1 are sent to the heat melting-dehydration-dechlorination-comminution unit for waste plastics 2 (including the heat melting-dehydration-dechlorination unit for waste plastics and the cooling and comminution unit), and firstly dehydrated and dechlorinated by the heat melting-dehydration-dechlorination unit for waste plastics to obtain the dehydrated and dechlorinated waste plastic and the hydrogen chloride-containing gas. The hydrogen chloride-containing gas is drawn into the hydrogen chloride absorption unit 9 through the vacuum system to contact with the hydrogen chloride absorbent to perform the hydrogen chloride absorption treatment. A small amount of non-condensable gas is discharged through pipeline 22. The dehydrated and dechlorinated waste plastic is subjected to cooling treatment and comminution treatment successively in the cooling and comminution unit to produce dehydrated and dechlorinated waste plastic particles. The dehydrated and dechlorinated waste plastic particles are placed in the waste plastic particles storage tank 3 for storage. The dehydrated and dechlorinated waste plastic particles in the waste plastic particles storage tank 3 are sent to the liquefaction unit for waste plastics 4 for liquefaction treatment to obtain the liquefied waste plastic. The liquefied waste plastic is sent to a viscosity reduction unit for waste plastics 5 for a viscosity reduction treatment to produce a liquefied waste plastic oil and a first dry gas. The viscosity-reduced liquefied waste plastic oil is sent via pipeline 10 together with the steam from pipeline 10 to the contact-cracking reaction unit 6. The fresh contact agent supplemented from pipeline 13 and the regenerated contact agent from pipeline 18 of the regenerator are sent to the contact-cracking reaction unit 6. The viscosity-reduced liquefied waste plastic oil contacts with the fluidized contact agent in the contact-cracking reaction unit 6 to perform the cracking reaction to produce the reaction product and the spent contact agent. The reaction product is sent to the subsequent separation unit 8 through pipeline 12 for separation treatment, wherein the second dry gas leaves via pipeline 22, and the liquefied gas, the gasoline fraction, the diesel fraction and the gas oil fraction leave via pipeline 16. The spent contact agent with charcoal and optionally the ash with charcoal are sent to the regeneration unit 7 via pipeline 14. The coke on the spent contact agent and the cracking dry gas from pipeline 21 (including the first dry gas from pipeline 22 and/or the second dry gas from pipeline 15) and the air from pipeline 19 undergo a complete combustion reaction. The generated regeneration flue gas leaves via pipeline 17 and can be directly discharged into the atmosphere after reaching the standard. The obtained regenerated contact agent leaves the regeneration unit 7 via pipeline 18, and the balance agent and the ash are discharged from pipeline 20.

As shown in FIG. 2, the waste plastic or dehydrated and dechlorinated waste plastic particles stored in the waste plastic storage tank 1 are sent to the preliminary melting-liquefaction-dechlorination unit for waste plastics 2, and dehydrated and dechlorinated to obtain the hydrogen chloride-containing gas phase material and the dechlorinated waste plastic material. The hydrogen chloride-containing gas phase material is pumped into the hydrogen chloride absorption unit 8 through a vacuum system, and contacts with the hydrogen chloride absorbent for the hydrogen chloride absorption treatment to obtain the chlorine-containing absorbent and the dechlorinated dry gas. A small amount of non-condensable gas is discharged through pipeline 9. The liquefaction unit for waste plastics adopts the quick heating liquefaction transportation equipment 3. The dechlorinated waste plastics liquid phase material from the preliminary melting-liquefaction-dechlorination unit for waste plastics 2 can leave to perform the cooling treatment and comminution treatment to produce the dechlorinated waste plastic particles, which are sent to the quick heating liquefaction transportation equipment 3 (liquefaction unit for waste plastics), or can be directly sent to the quick heating liquefaction transportation equipment 3 (liquefaction unit for waste plastics) to produce the molten dechlorinated waste plastics liquid phase material. The molten dechlorinated waste plastics liquid phase material is sent to the adiabatic viscosity reduction reactor 4 (viscosity reduction unit for waste plastics) for the viscosity reduction treatment to obtain the viscosity-reduced liquefied waste plastic oil, and the gas oil fraction from the separation unit 7 can also be simultaneously sent to the adiabatic viscosity reduction reactor 4 for reprocessing. The viscosity-reduced liquefied waste plastic oil is sent to the heating furnace 5 (heating unit) via pipeline 10. After being heated by the heating furnace 5, the high-temperature liquefied waste plastic is sent to the pyrolysis reaction unit 6 via pipeline 11 for pyrolysis reaction to obtain the pyrolysis product and coke. The pyrolysis product is sent to the subsequent separation unit 7 through pipeline 12 for separation treatment: the dry gas leaves via pipeline 15, the liquefied gas and the gasoline fraction leave via pipeline 14, and the diesel fraction leave via pipeline 13; the gas oil fraction at the column bottom leaves the separation unit via pipeline 16, wherein a part of the gas oil fraction can also be recycled to the adiabatic viscosity reduction reactor 4 (viscosity reduction unit for waste plastics) via pipeline 15 for reprocessing, or can leave as product via pipeline 17.

### EXAMPLES

The present disclosure is further described in detail below by way of Examples. The raw materials used in the examples can all be obtained through commercial sources.

The used contact agent named SL-1 is a contact agent containing 10 wt % alumina and 80 wt % kaolin, which is prepared by spray drying and then calcining. The specific preparation method is referred to CN102974383A; the average particle size of SL-1 is 80 μm.

The used catalytic cracking catalyst is a catalytic cracking catalyst with a trade name of CRC-1 (produced by Qilu Petrochemical Company), and the balance agent of the catalytic cracking catalyst is named SL-2, with an average particle size of 65 μm.

The quartz sand used is named SL-3, and its particle size is 300 μm.

The analytical method for chlorine content in liquefied waste plastics is: Q/SH 3360 270-2018.

The analysis methods for other elements in liquefied waste plastics are: carbon and hydrogen elements SH/T 0656-2017, oxygen element SH/T 0986, nitrogen element SH/T 0704-2010, and sulfur element SH/T 0842-2010.

Pyrolysis or cracking product distribution is obtained by the simulated distillation NB/SH/T 0829-2010 method.

The density analysis method of diesel and gas oil is SH/T0604-2000; the composition of pyrolysis or cracking gas is determined by RIPP 78-90 method; the hydrocarbon composition of naphtha, diesel, and the like is determined by chromatography analysis.

The fluorescence method (XRF) is used to test the residual chlorine content in the waste plastic raw material and the dechlorinated waste plastics liquid phase material obtained by dechlorination treatment. The measurement method of the molecular weight of plastics can refer to ISO 16014 and ASTM D6474-99; in the present invention, the molecular weight of plastics refers to the number average molecular weight.

The measurement method of the ash of plastics can refer to GB 508 (Petroleum Products-Determination of ash);

For the measurement method of the sulfur content of plastics, referring to Liang Chengjin et al.'s “Determination of sulfur element in plastic particles by microwave digestion ICP-AES” (Technology Innovation and Application, Issue 3, 2018, pp. 20-21).

The particle size of the contact agent is measured by a particle size detector.

The manufacturer of the high temperature flash pyrolysis chromatograph is Frontier Co., Ltd. of Japan, and the model is PY-3030.

The particle size of the contact agent is measured by a particle size detector.

In the following examples, the particle size of the particles obtained by the comminution treatment ranges from 100 to 2000 μm.

The contact cracking reactor is a fluidized bed reactor.

The viscosity is the apparent viscosity measured by a rotational viscometer according to SY/T 0520-2008. The rotational viscometer used in the examples is a Brookfield LVDV-3T, with a rotation speed of 20 rpm and a rotor size of SC4-34.

### REFERENCE EXAMPLE

Waste plastic packaging materials LDPE, HDPE, PS, PP and PVC were mixed in the mass ratio of 4:4:8:3:1, and the mixed plastic packaging materials were comminuted and dried to obtain mixed plastics. The chlorine content of the mixed plastics was 2.9 wt %. A twin screw-type heating transportation equipment was used as the preliminary melting-liquefaction-dechlorination equipment for the mixed plastics, and the feeding rate was about 100 kg/h. The outlet temperature was changed during the test, and the processing time under each outlet temperature condition was 0.1h. The vacuum degree of the twin screw-type heating transportation equipment was 100 mmHg. The morphology and chlorine content of the mixed plastics after transportation under different outlet temperature conditions were tested to obtain dechlorinated plastics RDCl-8-1 to R DCl-8-7. The properties of the obtained dechlorinated plastics RDCl-8-1 to RDCl-8-7 are shown in Table 1.

In the dechlorination process, the hydrogen chloride-containing gas phase material was drawn with a vacuum system and sent to the hydrogen chloride absorption unit to contact with the hydrogen chloride absorbent (NaOH solution) to perform the hydrogen chloride absorption treatment.

TABLE 1
Properties of dechlorinated plastics in Reference Examples

| | RDCl-8-i (i = 1-7) | | | | | | |
|---|---|---|---|---|---|---|---|
| Sample Name | 1 | 2 | 3 | 4 | 5 | 6 | 7 |
| Outlet Temp (° C.) | 330 | 320 | 310 | 300 | 285 | 250 | 220 |
| w(Cl)/(μg/g) | 750 | 1630 | 1720 | 2900 | 6430 | 11410 | 20223 |
| Dechlorination rate/weight % | 97.41 | 94.38 | 94.07 | 90.00 | 77.83 | 59.82 | 28.79 |

The dechlorinated plastic RDCl-8-6 in the Reference Example was heated to 250° C. by a screw-type heating transportation equipment and directly squeezed into a normal pressure container having a gas outlet with an internal temperature of 250° C. The temperature was kept for 60 minutes, and a sample of RDCl-8-6-60 was taken to test the viscosity. Its viscosity was too high and exceeded the measurement range. Its morphology was a plastic solid, and it could not flow by itself.

The dechlorinated plastic RDCl-8-3 in the Reference Example was further heated to 390° C. using a screw-type heating transportation equipment for 0.2h (liquefaction treatment procedure); then the rotational viscosity was measured after keeping at 390° C. for 30 min, 50 min and 70 min (using an adiabatic upflow viscosity reduction reactor) to obtain the viscosity-reduced liquefied waste plastic oils (respectively designated as RDCl-8-3-30, RDCl-8-3-50, and RDCl-8-3-70). The properties of the viscosity-reduced liquefied waste plastic oils are shown in the table below.

| Sample Name | RDCl-8-3-30 | RDCl-8-3-50 | RDCl-8-3-70 | RDCl-8-6-60 |
|---|---|---|---|---|
| Viscosity reduction temperature/° C. | 390 | 390 | 390 | 250 |
| Viscosity reduction time/min | 30 | 50 | 70 | 60 |
| Viscosity/(cP@200° C.) | 543 | 330.8 | 268.5 | — |

In the table, the symbol “-” in the viscosity column indicates that the viscosity is too high to be tested.

### Example 1A

The chlorine-containing waste plastic raw materials included LDPE, HDPE, PS, PP and PVC, and were mixed in a mass ratio of 4:4:8:3:2. The mixed plastic packaging material was comminuted and dried. The chlorine content in the mixed plastic is 5.1 wt %. The raw material was mixed and comminuted using a twin screw-type heating transportation equipment at 200° C. to obtain a hot mixed plastic particles HSL, whose properties are shown in Table 2.

Using HSL as raw material, using a twin screw-type heating transportation equipment as the preliminary melting-liquefaction-dechlorination equipment for waste plastics, the feeding rate was about 100 kg/h, firstly, the chlorine-containing waste plastic raw material was subjected to melting-dehydration treatment under a first temperature condition to obtain a dehydrated waste plastic; the first temperature was 150° C.; the time was 3 min; the heating rate of the melting-dehydration treatment was 80° C./min;
then, the dehydrated waste plastic was heated to a second temperature for dechlorination treatment to obtain a dehydrated and dechlorinated waste plastic and a hydrogen chloride-containing gas, wherein the second temperature was 320° C., the time was 0.2h, the vacuum degree was 70 mmHg, and the heating rate from the first temperature up to the second temperature was 100° C./min;
the dehydrated and dechlorinated waste plastic was subjected to cooling treatment and comminution treatment successively in a cooling and comminution unit to produce dehydrated and dechlorinated waste plastic particles DCl-1; the properties of the dehydrated and dechlorinated waste plastic particles DCl-1 are shown in Table 2;

In the dechlorination process, the hydrogen chloride-containing gas phase material was drawn with a vacuum system and sent to the hydrogen chloride absorption unit to contact with the hydrogen chloride absorbent (NaOH solution) to perform the hydrogen chloride absorption treatment.

Then the dehydrated and dechlorinated waste plastic particles DCl-1 were crushed, subjected to liquefaction treatment using a twin screw high-temperature liquefaction feeding equipment for waste plastic as the liquefaction unit for waste plastics, the condition of liquefaction treatment included: the outlet temperature was 420° C., and the residence time was 0.2h; then sent to a viscosity reduction tank for viscosity reduction treatment to obtain a viscosity-reduced liquefied waste plastic oil and a first dry gas. The temperature of the viscosity reduction treatment was 380° C., and samples were taken for analysis after a residence of 60 min (named as DCl-1-60). The viscosity of the viscosity-reduced liquefied waste plastic oil is shown in Table 3.

Using SL-1 as a contact agent, the viscosity-reduced liquefied waste plastic oil and steam were sent to the contact-cracking reaction unit (a contact cracking reactor), contacted with the fluidized contact agent for cracking reaction to obtain a reaction product and a spent contact agent, wherein the mass ratio of the contact agent to the waste plastic raw material was 5:1, and the condition of the cracking reaction included: reaction temperature of 550° C., weight hourly space velocity of 4h⁻¹, and mass ratio of steam to the waste plastic to be treated of 0.4:1; the product distribution of cracking reaction product is shown in Table 4.

### Example 1B

Referring to the process flow in Example 1A, the difference between this example and Example 1A is that the process conditions were changed, specifically including:

The feeding rate of the chlorine-containing waste plastic raw material was 100 kg/h, the condition of melting-dehydration treatment included: the first temperature was 100° C., the time was 0.5h; the condition of dechlorination treatment included: the second temperature was 308° C.; the time was 0.05h; the vacuum degree was 150 mmHg; the heating rate from the first temperature up to the second temperature was 50° C./min; the properties of dehydrated and dechlorinated waste plastic particles DCl-7 are shown in Table 2;
the condition of liquefaction treatment included: the outlet temperature was 380° C.; the residence time was 5 min; the condition of viscosity reduction treatment included: the reaction temperature was 380° C., the residence time was 10 min; the viscosity of the viscosity-reduced liquefied waste plastic oil is shown in Table 3.

The condition of cracking reaction included: the reaction temperature was 650° C., the weight hourly space velocity was 5h⁻¹, the mass ratio of the contact agent to the waste plastic to be treated was 30:1; the mass ratio of steam to the waste plastic to be treated was 0.05:1; the product distribution of cracking reaction product is shown in Table 4.

### Example 2.1

Using real waste plastic (chlorine content of about 3 wt %) as chlorine-containing waste plastic raw material, using a twin screw-type heating transportation equipment as the preliminary melting-liquefaction-dechlorination equipment for waste plastics, the feeding rate was about 100 kg/h, firstly, the chlorine-containing waste plastic raw material was subjected to melting-dehydration treatment under a first temperature condition to obtain a dehydrated waste plastic; the first temperature was 150° C.; the time was 0.2h; the heating rate of the melting-dehydration treatment was 90° C./min;
then, the dehydrated waste plastic was heated to a second temperature for dechlorination treatment to obtain a dehydrated and dechlorinated waste plastic and hydrogen chloride-containing gas, wherein the second temperature was 300° C., the time was 0.1 h, the vacuum degree was 100 mmHg, and the heating rate from the first temperature up to the second temperature was 80° C./min; the dehydrated dechlorinated waste plastic is named as DCl-2, and the properties of DCl-2 are shown in Table 2;

In the dechlorination process, the hydrogen chloride-containing gas phase material was drawn with a vacuum system and sent to the hydrogen chloride absorption unit to contact with the hydrogen chloride absorbent (Ca(OH)₂ solution) to perform the hydrogen chloride absorption treatment.

Then, the dehydrated and dechlorinated waste plastic DCl-2 was subjected to liquefaction treatment, using a twin-screw high-temperature liquefaction feeding equipment for waste plastic as the liquefaction unit for waste plastics, the condition of liquefaction treatment included: the outlet temperature was 400° C., the residence time was 0.2 h;
the liquefied dechlorinated plastic was then sent to a viscosity reduction tank for viscosity reduction treatment to obtain a viscosity-reduced liquefied waste plastic oil and a first dry gas. The temperature of the viscosity reduction treatment was 400° C. After different residence times (30, 50 and 70 minutes, respectively named as DCl-2-30, DCl-2-50 and DCl-2-70), samples were taken for analysis. The viscosity of the viscosity-reduced liquefied waste plastic oil is shown in Table 3.

Using SL-2 as a contact agent, the viscosity-reduced liquefied waste plastic oil and steam were sent to the contact-cracking reaction unit (a contact cracking reactor), contacted with the fluidized contact agent for cracking reaction to obtain a reaction product and a spent contact agent, wherein the mass ratio of the contact agent to the waste plastic raw material was 7:1, and the condition of the cracking reaction included: reaction temperature of 510° C., weight hourly space velocity of 4h⁻¹, and mass ratio of steam to the waste plastic to be treated of 0.1:1; the product distribution of cracking reaction product is shown in Table 4.

TABLE 2
Properties of plastic particles

| | Example | | | | | |
|---|---|---|---|---|---|---|
| | 1A | | 1B | 2.1 | 3 | 4 |
| | Sample Name | | | | | |
| | HSL | DCl-1 | DCl-7 | DCl-2 | DCl-3 | DCl-4 |
| W(Ash)/% | | | | 20.204 | 11.363 | 2.86 |
| W(O)/% | 0.68 | <0.2 | <0.2 | 8.38 | 8.43 | 1.45 |
| W(C)/% | 84.05 | 85.87 | 85.75 | 66.94 | 66.02 | 83.28 |
| W(H)/% | 12.47 | 14.43 | 14.55 | 9.23 | 9.47 | 13.25 |
| W(S)/% | 99 | 181 | 176 | 0.053 | 0.084 | <0.1 |
| W(N)/% | | | | 0.31 | 0.18 | 0.028 |
| W(Cl)/% | 3.2 | 0.142 | 0.198 | 0.473 | 0.834 | 0.0162 |

W(metal analysis)/(μg/g)

| | | | | | | |
|---|---|---|---|---|---|---|
| Al | | | | 0.329 | 0.506 | — |
| Ca | 0.049 | 0.728 | 0.679 | 6.934 | 6.326 | 0.709 |
| Fe | — | 0.19 | 0.21 | 0.434 | 0.894 | — |
| Mg | | | | 0.065 | 0.165 | — |
| Na | | | | — | 0.123 | — |
| Si | 0.025 | 0.051 | 0.045 | 0.411 | 0.852 | 0.131 |
| Ti | | | | 0.252 | 0.211 | — |

TABLE 3
Viscosity of the viscosity-reduced plastic oil

| | Sample | Temperature for | Time for viscosity | Viscosity/ |
|---|---|---|---|---|
| | Name | viscosity reduction/° C. | reduction/min | (cP@200° C.) |
| Example 1A | DCl-1-60 | 380 | 60 | 192.5 |
| Example 1B | DCl-7-10 | 380 | 10 | 272.1 |
| Example 2.1 | DCl-2-30 | 400 | 30 | 1820 |
| Example 2.1 | DCl-2-50 | 400 | 50 | 567.6 |
| Example 2.1 | DCl-2-70 | 400 | 70 | 286.2 |
| Example 3 | DCl-3-20 | 410 | 20 | 282.8 |

TABLE 4
Product distribution

| | Example | | | | | | | Comp |
|---|---|---|---|---|---|---|---|---|
| | 1A | 1B | 2.1 | 3 | 4.1 | 4.2 | 5.1 | Ex. 2 |
| CO/wt % | 0 | 0 | 0.3 | 0.22 | 0.04 | 0.03 | 0 | 0 |
| CO₂/wt % | 0 | 0 | 1.2 | 1.04 | 0.45 | 0.6 | 0 | 0 |
| Dry gas/wt % | 0.98 | 2.15 | 0.82 | 0.88 | 1.73 | 0.81 | 0.91 | 1.18 |
| Liquefied gas/wt % | 11.71 | 20.72 | 3.42 | 6.19 | 23.05 | 18.39 | 11.34 | 5.38 |
| Gasoline (<205° C.)/wt % | 63.11 | 42.96 | 32.93 | 35.33 | 55.51 | 63.57 | 59.78 | 23.28 |
| Diesel (205-350° C.)/wt % | 9.82 | 8.45 | 35.85 | 33.58 | 8.84 | 10.1 | 11.28 | 17.3 |
| Gas oil (350-524° C.)/wt % | 3.27 | 3.89 | 7.47 | 6.97 | 3.15 | 2.15 | 4.13 | 39.97 |
| Heavy gas oil (>524° C.)/wt % | 0 | 0 | 0.6 | 0.86 | 0 | 0 | 0 | 12.89 |
| Coke/wt % | 11.11 | 21.83 | 17.41 | 14.93 | 7.23 | 4.35 | 12.56 | <1 |
| Total/wt % | 100 | 100 | 100 | 100 | 100 | 100 | 100 | 100 |
| w(Si product)/(μg/g) | <1 | <1 | <1 | <1 | <1 | <1 | <1 | <1 |
| w(Cl)/(μg/g) | 50 | 32 | 9 | 15 | <3 | <5 | 26 | 270 |

### Example 2.2

The real waste plastic (chlorine content was about 3 wt/%) was treated, using a twin screw-type heating transportation equipment as the preliminary melting-liquefaction-dechlorination equipment for waste plastic, wherein the feeding rate was about 100 kg/h, the outlet temperature was 300° C., the treatment time was 0.1 h, the vacuum degree of the screw-type heating transportation equipment was 70 mmHg, to obtain a liquefied dechlorinated plastic DCl-9. The absorption procedure of the hydrogen chloride-containing gas obtained by the dechlorination treatment was the same as that of Reference Example.

The DCl-9 was further heated to 420° C. by a screw-type heating transportation equipment for 0.2 h (liquefaction process); then kept at 420° C. for 30 min (using an adiabatic upflow viscosity reduction reactor), and a sample was taken to measure the rotational viscosity (named as DCl-9-30) to obtain the viscosity-reduced liquefied waste plastic oil. The viscosity result is shown in Table 5.

TABLE 5
Viscosity of the viscosity-reduced plastic

| | Example 2.2 |
|---|---|
| Sample Name | DCl-9-30 |
| Viscosity reduction temperature/° C. | 420 |
| Viscosity reduction time/min | 30 |
| Viscosity/(cP@200° C.) | 282.8 |

The DCl-9-30 sample was first heated in a heating furnace to obtain a high-temperature liquefied waste plastic, and the outlet temperature of the heating furnace was 480° C.; then the high-temperature liquefied waste plastic was sent to a pyrolysis reaction device and pyrolyzed at 480° C. for 2 hours. The obtained pyrolysis products were separated by a separation unit and then the product distribution test was performed. The distribution of the pyrolysis reaction products is shown in Tables 6 and 7.

TABLE 6
Distribution of the pyrolysis products
of waste plastic (dry ash-free)

| | Example |
|---|---|
| Product distribution/wt % | Example 2.2 |
| CO | 0.86 |
| CO2 | 7.74 |
| Dry gas | 3.82 |
| Liquefied gas | 4.59 |
| Gasoline (<180° C.) | 25.3 |
| Diesel (180-350° C.) | 21.8 |
| Gas oil (>350° C.) | 11.7 |
| Coke | 24.04 |
| Total | 100.0 |

### Example 3

TABLE 7
Mass composition of dry gas and liquefied
gas from pyrolysis of waste plastics

| | Example |
|---|---|
| Composition/wt % | Example 2.2 |
| Dry gas | 52.4 |
| Hydrogen | 4.29 |
| Methane | 18 |
| Ethane | 22.54 |
| Ethylene | 7.57 |
| Liquefied gas | 47.6 |
| Propylene | 17.47 |
| Butene | 15.44 |
| Propane | 10.27 |
| Isobutane | 0.8 |
| n-Butane | 3.62 |
| Total | 100.00 |

A real waste plastic (chlorine content was about 6 wt/%) was used as the chlorine-containing waste plastic raw material, and a twin screw-type heating transportation equipment was used as the preliminary melting-liquefaction-dechlorination equipment for waste plastics. The feeding rate was about 100 kg/h. First, the chlorine-containing waste plastic raw material was subjected to the melting-dehydration treatment under a first temperature condition to obtain a dehydrated waste plastic; the first temperature was 130° C.; the time was 0.1 h; the heating rate of the melting-dehydration treatment was 80° C./min.

Then, the dehydrated waste plastic was heated to a second temperature for dechlorination treatment to obtain a dehydrated and dechlorinated waste plastic and a hydrogen chloride-containing gas, wherein the second temperature was 320° C., the time was 0.2h, the vacuum degree was 90 mmHg, and the heating rate from the first temperature up to the second temperature was 100° C./min; the dehydrated and dechlorinated waste plastic is named as DCl-3, and the properties of DCl-3 are shown in Table 2.

In the dechlorination process, the hydrogen chloride-containing gas phase material was drawn with a vacuum system and sent to the hydrogen chloride absorption unit to contact with the hydrogen chloride absorbent (NaOH solution) to perform the hydrogen chloride absorption treatment.

Then, the dehydrated and dechlorinated waste plastic DCl-3 was subjected to liquefaction treatment, using a twin-screw high-temperature liquefaction feeding equipment for waste plastic as the liquefaction unit for waste plastics, the condition of liquefaction treatment included: the outlet temperature was 420° C., the residence time was 0.1h.

The liquefied dechlorinated plastic was then sent to a viscosity reduction tank for viscosity reduction treatment to obtain a viscosity-reduced liquefied waste plastic oil and a first dry gas. The temperature of the viscosity reduction treatment was 410° C. After a residence time of 20 min, a sample was taken for analysis (named as DCl-3-20). The viscosity of the viscosity-reduced liquefied waste plastic oil is shown in Table 3.

Using SL-3 as a contact agent, the viscosity-reduced liquefied waste plastic oil and steam were sent to the contact-cracking reaction unit (a contact cracking reactor), contacted with the fluidized contact agent for cracking reaction to obtain a reaction product and a spent contact agent, wherein the mass ratio of the contact agent to the waste plastic raw material was 7:1, and the condition of the cracking reaction included: reaction temperature of 590° C., weight hourly space velocity of 4h⁻¹, and mass ratio of steam to the waste plastic to be treated of 0.2:1; the product distribution of the cracking reaction products is shown in Table 4.

### Example 4

Waste agricultural film was placed on a medium-sized experimental device for pyrolysis of waste plastic. A twin screw-type heating transportation equipment was used as the preliminary melting-liquefaction-dechlorination equipment for waste plastics. The feeding rate was about 5 kg/h, the condition of melting-dehydration treatment included: the first temperature was 150° C.; the time was 0.1 h; the condition of dechlorination treatment included: the second temperature was 300° C.; the time was 0.1h, the heating rate from the first temperature up to the second temperature was 100° C./min; the vacuum degree of the screw-type heating transportation equipment was 150 mmHg. A dehydrated and dechlorinated waste plastic sample DCl-4 was obtained. Its properties are shown in Table 2.

The same twin screw-type heating transportation equipment was used again to liquefy the dehydrated and dechlorinated waste plastic DCl-4. The condition of liquefaction treatment included: the outlet temperature was listed in Table 8, the residence time was 0.2 h, and a liquefied waste plastic was obtained; then the liquefied waste plastic was sent to the viscosity reduction reactor from the outlet of the twin screw-type heating transportation equipment, and the viscosity reduction was performed at different temperatures and residence times to obtain a series of the viscosity-reduced waste plastic DCl-4 samples, wherein the internal temperature of the viscosity reduction reactor, the viscosity reduction reaction time and the viscosity of the viscosity-reduced waste plastic are listed in Table 8.

TABLE 8
Conditions of viscosity reduction and properties of viscosity-reduced waste plastic

| Sample Name | DCl-4-1 | | | DCl-4-2 | | | DCl-4-3 | | | DCl-4-4 | | |
|---|---|---|---|---|---|---|---|---|---|---|---|---|
| Screw outlet | 380 | | | 390 | | | 400 | | | 410 | | |
| temperature in | | | | | | | | | | | | |
| liquefaction | | | | | | | | | | | | |
| treatment/° C. | | | | | | | | | | | | |
| Internal temperature | 380 | | | 390 | | | 396 | | | 408 | | |
| of viscosity | | | | | | | | | | | | |
| reduction reactor/° C. | | | | | | | | | | | | |
| Viscosity reduction | 20 | 40 | 60 | 20 | 40 | 60 | 20 | 40 | 60 | 20 | 40 | 60 |
| reaction time/min | | | | | | | | | | | | |
| Viscosity/(cP@200° | — | — | 7043.0 | — | 2496.0 | 587.2 | 11760.0 | 1400.0 | 351.6 | 825.6 | 181.6 | 62.1 |
| C.) | | | | | | | | | | | | |

In the table, the symbol “-” in the viscosity column indicates that the viscosity is too high to be tested. In addition, DCl-4 was further heated to 400° C. by a screw-type heating transportation equipment for 0.1 h (liquefaction treatment procedure); then the rotational viscosity was measured after keeping at 400° C. for 30 min, 50 min and 70 min (using an adiabatic upflow viscosity reduction reactor) to obtain the viscosity-reduced liquefied waste plastic oils (respectively named as DCl-8-30, DCl-8-50, and DCl-8-70). The viscosities are shown in Table 9.

TABLE 9
Conditions of viscosity reduction and properties
of viscosity-reduced waste plastic

| Sample Name | DCl-8-30 | DCl-8-50 | DCl-8-70 |
|---|---|---|---|
| Temperature for viscosity reduction/ | 400 | 400 | 400 |
| ° C. | | | |
| Time for viscosity reduction/min | 30 | 50 | 70 |
| Viscosity/(cP@200° C.) | 1430 | 267.6 | 86.2 |

### Example 4.1

Using DCl-4-2-60 as raw material and SL-2 as contact agent, the viscosity-reduced liquefied waste plastic oil and steam were sent to the contact-cracking reaction unit (a contact cracking reactor), contacted with the fluidized contact agent for cracking reaction to obtain a reaction product and a spent contact agent, wherein the mass ratio of contact agent to waste plastic raw material was 7:1, the condition of cracking reaction included: the reaction temperature was 510° C., the weight hourly space velocity was 4h⁻¹, the mass ratio of steam to the waste plastic to be treated was 0.4:1; the product distribution of cracking reaction products is shown in Table 4.

### Example 4.2

Using DCl-4-2-60 as raw material, the same process as in Example 4.1 was adopted, except that: SL-1 was used as the contact agent, and the spent contact agent (having a carbon content of 1.3 wt %) obtained from the cracking reaction unit was introduced into the regeneration unit for regeneration treatment, and the regeneration treatment was carried out in a dense-phase fluidized bed regenerator; the condition of the regeneration treatment included: the residence time of air was 3s, the gasification temperature of dense bed was 660° C., the introduced gas was a gas having an oxygen gas content of 21 vol %, and the dense bed had a linear velocity of 0.3 m/s. The regenerated contact agent obtained was introduced into the cracking reaction unit together with the fresh contact agent (the weight ratio of the regenerated contact agent to the fresh contact agent was 20:1); and the first dry gas generated from the viscosity reduction reactor for waste plastic and the second dry gas obtained from the separation unit were introduced into the regenerator for the continuing use, and the spent contact agent was completely combusted (the introduction amounts of the first dry gas and the second dry gas could be adjusted according to the actual regeneration and combustion conditions), and the other process conditions were identical to those in Example 5. The product distribution of the cracking reaction product is shown in Table 4.

### Example 4.3

The DCl-8-50 sample was first heated in a heating furnace to obtain a high-temperature liquefied waste plastic, and the outlet temperature of the heating furnace was 500° C.; the steam injection amount was 0.5 wt/%; then the high-temperature liquefied waste plastic obtained was sent to a pyrolysis reaction device and pyrolyzed at 480° C. for 2 hours. The obtained pyrolysis products were separated by a separation unit and then the product distribution test was performed. The distribution of the pyrolysis reaction products is shown in Tables 10 and 11.

TABLE 10
Distribution of the pyrolysis products
of waste plastic (dry ash-free)

| | Example |
|---|---|
| Product distribution/wt % | Example 4.3 |
| CO | 0.12 |
| CO₂ | 0.35 |
| Dry gas | 6.23 |
| Liquefied gas | 12.96 |
| Gasoline (<180° C.) | 28.69 |
| Diesel (180-350° C.) | 27.68 |
| Gas oil (>350° C.) | 21.1 |
| Coke | 2.56 |
| Total | 100.0 |

TABLE 11
Mass composition of dry gas and liquefied
gas from pyrolysis of waste plastics

| | Example |
|---|---|
| Composition/wt % | Example 4.3 |
| Dry gas | 32.42 |
| Hydrogen | 0.41 |
| Methane | 8.42 |
| Ethane | 13.05 |
| Ethylene | 10.54 |
| Liquefied gas | 67.58 |
| Propylene | 23.61 |
| Butene | 17.01 |
| Propane | 17.64 |
| Isobutane | 0.42 |
| n-Butane | 8.90 |
| Total | 100 |

### Example 4.4

A medium-sized device for continuous pyrolysis of waste plastics was used. DCl-4 as raw material was liquefied at 400° C., and then kept at 380° C. for a period of time for the viscosity reduction treatment (using an adiabatic upflow viscosity reduction reactor). The viscosity-reduced liquefied waste plastic oil obtained was then sent to a heating device (heating furnace). Different furnace outlet temperatures were set, and the pyrolysis was performed under different temperature conditions (the pyrolysis temperature in this embodiment was the corresponding furnace outlet temperature), and the obtained pyrolysis products were separated by a separation unit and then subjected to a product distribution test. The reaction conditions and the distribution of the pyrolysis reaction products are shown in Table 12.

TABLE 12

| | Condition No. | | | | | |
|---|---|---|---|---|---|---|
| | 1 | 2 | 3 | 4 | 5 | 6 |
| Test items | | | | | | |
| Internal temperature of viscosity | 380 | 380 | 380 | 380 | 380 | 380 |
| reduction reactor/° C. | | | | | | |
| Viscosity reduction time/min | 60 | 60 | 60 | 2 | 10 | 60 |
| Reprocessed gas oil fraction/waste | 0 | 0 | 0 | 0 | 0 | 1:1 |
| plastic to be treated (weight ratio) | | | | | | |
| Furnace outlet temperature/° C. | 480 | 500 | 520 | 520 | 460 | 480 |
| Pyrolysis column pressure/MPa | 0.15 | 0.15 | 0.15 | 0.25 | 0.6 | 0.15 |
| Product mass fraction/% | | | | | | |
| CO | 0.16 | 0.1 | 0.23 | 0.04 | 0.14 | 0.15 |
| CO₂ | 0.04 | 0.03 | 0.05 | 0.03 | 0.05 | 0.04 |
| Gas | 7.7 | 8.36 | 9.45 | 9.4 | 7.5 | 9.18 |
| Liquid | 81.47 | 82.33 | 80.43 | 79.29 | 81.05 | 84.48 |
| Coke + ash | 10.63 | 9.18 | 9.84 | 11.24 | 11.26 | 6.15 |
| Total | 100.00 | 100.00 | 100.00 | 100.00 | 100.00 | 100.00 |

Using a medium-sized device for continuous pyrolysis of waste plastics, DCl-4 was further heated to 400° C. by a screw-type heating transportation equipment for 0.2 h (liquefaction treatment); then kept warm and subjected to the viscosity reduction treatment, the viscosity reduction temperature was 380° C., and the viscosity reduction time was 1 h (using an adiabatic upflow viscosity reduction reactor); when the outlet temperature of the heating furnace (the reaction temperature) was 500° C. and the pressure of the pyrolysis column (the reaction pressure) was 0.15 MPa, the distribution of products obtained from processing waste agricultural film particles (dry ash-free treatment) is shown in Table 13, and the distribution of gas phase products is shown in Table 14. The liquid product was cut to obtain naphtha, diesel and gas oil components, and their properties are shown in Table 15. The properties of the coke product are shown in Table 16.

### Comparative Example 4.5

Referring to the process flow of Example 4.5, the same waste plastic raw material was used. The difference from Example 4.5 was that DCl-4 was used as raw material without liquefaction treatment and viscosity reduction treatment, but was directly introduced into the heating furnace for heating, and then pyrolysis reaction was carried out. The specific conditions were identical to those of Example 4.5. The product distribution (dry ash-free based treatment) is shown in Table 13.

TABLE 13
Distribution of pyrolysis products of
Example 4.5 and Comparative Example 4.5

| | | Comparative |
|---|---|---|
| | Example 4.5 | Example 4.5 |
| Item | Mass fraction/% | Mass fraction/% |
| CO | 0.21 | 0.3 |
| CO₂ | 0.40 | 2.88 |
| Dry gas | 6.10 | 8.73 |
| Liquefied gas | 10.59 | 9.89 |
| Naphtha fraction (<180° C.) | 25.50 | 33.88 |
| Diesel fraction (180° C.-350° C.) | 32.68 | 21.53 |
| Gas oil fraction (>350° C.) | 19.75 | 13.79 |
| Coke | 4.78 | 9.0 |
| Total | 100.00 | 100.00 |
| Liquid yield (containing | 88.52 | 79.09 |
| liquefied gas) | | |

TABLE 14
Composition of pyrolysis gas from Example 4.5

| Item | |
|---|---|
| Mass composition/% | Value |
| Hydrogen | 1.91 |
| Methane | 8.36 |
| Ethane | 16.29 |
| Ethylene | 8.73 |
| Propane | 16.07 |
| Propylene | 22.11 |
| Butane | 9.04 |
| iso-Butane | 0.56 |
| n-Butane | 8.48 |
| Butene | 16.93 |
| n-Butene | 9.31 |
| iso-Butene | 4.55 |
| trans-Butene | 1.74 |
| cis-Butene | 1.33 |
| 1,3-Butadiene | 0.56 |
| Total | 100 |

TABLE 15
Properties of pyrolysis products of Example 4.5

| Item | Naphtha | Diesel | Gas oil |
|---|---|---|---|
| Density(20° C.)/(kg/m³) | 740.1 | 798.7 | 844.7 |
| Bromine value/(gBr/100 mL) | 43.1 | 15.7 | |
| PONA/%(Hydrocarbon composition/%) | | | |
| Paraffin | 25.96 | 42.3 | 47.3 |
| Naphthene | 7.13 | | |
| Olefin | 58.84 | 47.8 | 40.3 |
| Aromatics | 8.07 | 9.9 | 12.4 |
| C/% | 86.2 | 85.86 | 85.84 |
| H/% | 13.8 | 14.14 | 13.94 |
| S/(mg/kg) | 3.3 | 5.8 | 12 |
| N/(mg/kg) | 31 | 47 | 74 |
| Cl/(mg/kg) | 5.4 | 7.5 | 10 |
| Si/(mg/kg) | 5 | 7 | 9.5 |
| O/(mg/L) | 416 | <300 | 0.22(%) |
| Distillation range/° C. | | | |
| Initial distillation point | 24.2 | 172.2 | 341.5 |
| 5% | 41.4 | 193.8 | 356.5 |
| 50% | 128.7 | 269.8 | 419.7 |
| 95% | 177.6 | 345.9 | 529.9 |
| Final distillation point | 197.0 | 360.8 | 581.5 |

### Example 5.1

TABLE 16
Properties of coke

| Item | Value |
|---|---|
| Ash, w % | 45.96 |
| Moisture, w % | 0.96 |
| Volatile matter, w % | 29.42 |
| Low calorific value/(kJ/kg) | 10.74 |
| Packing density/(kg/m³) | 672 |
| C, w % | 53.39 |
| S, w % | 0.65 |
| Cl, w % | 0.152 |
| Metal analysis/% | |
| Na | 1.20 |
| Mg | 5.09 |
| Al | 2.18 |
| Si | 5.93 |
| P | 0.21 |
| K | 1.12 |
| Ca | 37.57 |
| Ti | 3.35 |
| Fe | 3.21 |
| Zn | 0.23 |
| Ba | 3.46 |

Using SL-1 as a contact agent, the viscosity-reduced liquefied waste plastic oil RDCl-8-3-70 and steam were sent to the contact-cracking reaction unit (a contact cracking reactor), contacted with the fluidized contact agent for cracking reaction to obtain a reaction product and a spent contact agent, wherein the mass ratio of the contact agent to the waste plastic raw material was 7:1, and the condition of the cracking reaction included: reaction temperature of 550° C., weight hourly space velocity of 4h⁻¹, and mass ratio of steam to the waste plastic to be treated of 0.3:1; the product distribution of the cracking reaction products is shown in Table 4.

### Example 5.2

The RDCl-8-3-70 sample was first heated in a heating furnace to obtain a high-temperature liquefied waste plastic, and the outlet temperature of the heating furnace was 390° C.; then the obtained high-temperature liquefied waste plastic was sent to a pyrolysis reaction device (a pyrolysis column) and pyrolyzed at 480° C. for 2 hours. The obtained pyrolys is products were separated by a separation unit and then the product distribution test was performed. The distribution of the pyrolysis reaction products is shown in Tables 17 and 18.

TABLE 17
Distribution of the pyrolysis products
of waste plastic (dry ash-free)

| | Example |
|---|---|
| Product distribution/wt % | Example 5.2 |
| CO | |
| CO2 | |
| Dry gas | 3.71 |
| Liquefied gas | 6.79 |
| Gasoline (<180° C.) | 42.71 |
| Diesel (180-350° C.) | 29.53 |
| Gas oil (>350° C.) | 16.16 |
| Coke | 1.1 |
| Total | 100.0 |

TABLE 18
Mass composition of dry gas and liquefied
gas from pyrolysis of waste plastics

| | Example |
|---|---|
| Composition/wt % | Example 5.2 |
| Dry gas | 35.34 |
| Hydrogen | 0.14 |
| Methane | 7.52 |
| Ethane | 16.42 |
| Ethylene | 11.26 |
| Liquefied gas | 64.66 |
| Propylene | 29.28 |
| Butene | 17.18 |
| Propane | 12.95 |
| iso-Butane | 0.63 |
| n-Butane | 4.62 |
| Total | 100.00 |

### Comparative Example 1

Referring to the process flow of Example 1A, the same waste plastic raw material was used, and the difference from Example 1 A was that the dehydrated and dechlorinated waste plastic particles DCl-1 were used as raw material without liquefaction treatment and viscosity reduction treatment, but were directly introduced into the contact-cracking reaction unit. In this comparative example, since the viscosity of the liquefied waste plastic was too high, it was impossible to perform the dispersion atomization with steam, and it could not be continuously sent to the contact-cracking reaction unit.

### Comparative Example 2

This comparative example was used to illustrate the processing technology of cracking waste plastics in batch in a reactor, which specifically included:

The plastic packaging material containing LDPE, HDPE, PS, PP and PVC (according to the mass ratio of 4:4:8:3:2) was comminuted and dried (chlorine content was 2.6 wt/%), and then mixed with a cracking gas oil in a weight ratio of mixed waste plastics:cracking gas oil of 3:1, put into an autoclave with a stirrer, and the air was discharged from the reactor by nitrogen purging. The temperature was set at 350° C. and the reaction time was 1 hour to prepare a liquefied waste plastic (denoted as FSL-1).

Using SL-1 as contact agent, a contact cracking reaction was carried out in a manner similar to Example 1A. The condition of the contact cracking reaction included: a cracking temperature of 505° C., a space velocity of 20 h⁻¹, a catalyst-oil ratio of 7, and a water-oil ratio of 0.2. The product distribution of the cracking reaction products is shown in Table 4.

The properties of the cracking gas oil used are listed in the table below.

| | |
|---|---|
| Density(20° C.)/(g/cm³) | 1.1415 |
| Total acid value/(mgKOH/100 mL) | 0.1 |
| Residual carbon value/% | 5.08 |
| w(Element)/% | |
| C | 89.88 |
| H | 6.52 |
| S | 3.30 |
| N | 0.30 |
| w(Metal)/(μg/g) | |
| Fe | 4.9 |
| Ni | 1.3 |
| V | <0.1 |
| Na | 1.0 |
| Ca | 0.6 |
| w(SARA)/% | |
| Saturates | 3.3 |
| Aromatics | 82.4 |
| Resins | 13.3 |
| Asphaltenes | 1.0 |

1. A method for processing plastics, characterized in that the method comprises the following steps:
S1. the plastic to be treated is sent to a liquefaction unit for liquefaction treatment to produce a liquefied material;
S2. subjecting the liquefied material to heat treatment in a viscosity reduction unit to reduce its viscosity to produce a viscosity-reduced liquefied material;
S3. the viscosity-reduced liquefied material is sent to a cracking reaction unit for cracking reaction to produce a reaction product;
S4. the reaction product is sent to a separation unit for separation treatment.

2-26. (canceled)

27. The processing method according to claim 1, characterized in that, in step S1, the plastic to be treated satisfies one or more of the following conditions:
(1) the chlorine content of the plastic to be treated is less than 10 wt %; and/or
(2) the plastic to be treated contains PVC, preferably the content of PVC is less than 10 wt %; and/or
(3) the plastic to be treated includes one or more of LDPE, HDPE, PS, PP, PET and PVC; and/or
(4) the plastic to be treated has an ash content of 1-40 wt %, e.g., 3-30 wt % or 3-20 wt %; and/or
optionally in step S1, a heating liquefaction transportation equipment (preferably a rapid heating liquefaction transportation equipment) is used in the liquefaction unit for waste plastics to perform the liquefaction treatment; optionally, the heating liquefaction transportation equipment comprises a first screw-type heating transportation equipment, e.g., twin screw-type or single screw-type transportation equipment; preferably, the first screw-type heating transportation equipment is a twin screw-type or single screw-type heating transportation equipment with heating; preferably, the condition of the liquefaction treatment includes: an outlet temperature is 370-480° C., e.g. 380-480° C., 380-450° C. or 400-450° C.; a residence time is 5-30 min, e.g. 5-20 min, or 5-15 min; and/or
optionally in step S2, a viscosity reduction reactor is used in the viscosity reduction unit for waste plastics to perform the viscosity reduction treatment;
preferably, the viscosity reduction reactor is an adiabatic reactor;
preferably, the condition of the viscosity reduction treatment includes:
the reaction temperature is 350-450° C., e.g. 370-450° C., 380-420° C., 350-400° C., 370-410° C., 390-450° C. or 390-420° C.; preferably, the reaction temperature is not greater than, e.g. below the outlet temperature of the liquefaction treatment in step S1;
the residence time is 10-200 min, e.g. 10-180 min, 15-120 min, 20-120 min, 20-90 min, 30-120 min, 30-90 min, 50-90 min, 50-70 min, 20-60 min, or 30-70 min; and/or
optionally in step S2, a viscosity reduction reactor is used in the viscosity reduction unit for waste plastics to perform the viscosity reduction treatment; the viscosity reduction reactor does not significantly change the temperature of the material sent to the reactor; preferably, the viscosity reduction reactor is equipped with a temperature-control and heating device so that the temperature of the material sent to the reactor does not significantly change; wherein “the temperature of the material sent to the reactor does not significantly change” means that the temperature is maintained within a range of 90%-110%, e.g. 92%-108%, or 95%-105%, or 98%-102% of the temperature of the material sent to the reactor, and the temperature of the material sent to the reactor is represented by the reactor outlet temperature; and/or
optionally in step S3, the cracking reaction unit is a contact-cracking reaction unit,
in the contact-cracking reaction unit, a cracking reaction is performed by contacting with a contact agent in a fluidized state to produce a reaction product and a spent contact agent;
optionally, the spent contact agent is sent to a regeneration unit, and the spent contact agent is regenerated in the presence of oxygen gas to produce a regenerated contact agent and a regeneration flue gas; and the regenerated contact agent is returned to the contact-cracking reaction unit for continuous use; and/or
optionally in step S3, the condition of the cracking reaction includes: the reaction temperature is 490-750° C., the weight hourly space velocity is 1-100h⁻¹, and the mass ratio of the contact agent to the waste plastic to be treated is 5-30:1; preferably, the reaction temperature is 500-650° C., the weight hourly space velocity is 3-60h⁻¹, the mass ratio of the contact agent to the waste plastic to be treated is 6-20:1; preferably, the viscosity-reduced liquefied waste plastic oil and steam are sent to the contact-cracking reaction unit; preferably, the mass ratio of steam to the waste plastic to be treated is 0.05-1:1, e.g., 0.1-0.5:1; and/or
optionally in step S3, the contact agent is one or more of silica/alumina material catalyst, quartz sand or coal coke powder; preferably, the contact agent has a particle size of 20-3000 μm; optionally, the silica/alumina material is selected from a molecular sieve-containing catalyst and/or a molecular sieve-free catalyst; preferably, the molecular sieve-containing catalyst is one or more of a catalyst containing one or more molecular sieves of X molecular sieve, Y molecular sieve, mordenite, ZSM-5, pillared clay molecular sieve, and SAPO, and a waste FCC catalyst; preferably, the molecular sieve-free catalyst is a catalyst prepared with one or more of a first Raw Material as raw material, wherein the first Raw Material includes amorphous silica-alumina, clay, kaolin, montmorillonite, rectorite, illite, chlorite, pseudo-boehmite and silica; or the molecular sieve-free catalyst is a catalyst prepared from one or more of a second Raw Material treated by acid washing, calcining and sieving as raw material, the second Raw Material includes amorphous silica-alumina, clay, kaolin, montmorillonite, rectorite, illite and chlorite; or a catalyst prepared from one or more of the second Raw Material treated by acid washing, calcining and sieving and pseudo-boehmite and/or silica as raw material; optionally, the coal coke powder is coal powder and/or petroleum coke powder; and/or
optionally in step S3, the cracking reaction unit is a pyrolysis reaction unit, wherein the viscosity-reduced liquefied waste plastic oil is subjected to a heating treatment in a material heating unit to produce a high-temperature liquefied waste plastic, and then the high-temperature liquefied waste plastic is introduced into the pyrolysis reaction unit to perform a pyrolysis reaction to produce a pyrolysis product and a coke; preferably, the material heating unit include a heating furnace; and/or the condition of the heating treatment includes: the furnace outlet temperature is 450° C.-550° C., e.g., 460° C.-520° C.; optionally, the steam injection amount is 0.5-5 wt %, preferably 1-3 wt %; and/or the condition of the pyrolysis reaction includes: the pyrolysis column top pressure is 0.05-0.6 MPa, e.g., 0.1-0.3 MPa; the pyrolysis reaction temperature is 450-520° C., e.g., 480-520° C.; and/or
optionally in step S4, the reaction product is sent to a separation unit for separation treatment to produce a dry gas, a liquefied gas, a gasoline fraction (<180° C.), a diesel fraction (180-350° C.) and a gas oil fraction (>350° C.).

28. The processing method according to claim 1, characterized in that, the heat treatment in step S2 allows the material leaving the reactor to have a viscosity of less than 12000 cP@200° C., e.g. 5000-10000 cP@200° C., 6000-9000 cP@200° C., 100-12000 cP@200° C., 100-2000 cP@200° C., 100-1500 cP@200° C., 100-1000 cP@200° C., 100-500 cP@200° C.

29. The processing method according to claim 1, characterized in that, the cracking reaction carried out in the contact-cracking reaction unit in step S3 also produces an ash with charcoal;
the method further comprises: the ash with charcoal and a spent contact agent are sent to a regeneration unit, and in the presence of oxygen gas, the spent contact agent and the charcoal of the ash with charcoal are subjected to a complete combustion reaction to produce a regeneration flue gas and a regenerated contact agent;
preferably, the method further comprises:
at least a part of a first dry gas and/or at least a part of a second dry gas are sent to the regeneration unit, and in the presence of oxygen gas and dry gas, the spent contact agent and the ash with charcoal are subjected to a complete combustion reaction to produce a regeneration flue gas and a regenerated contact agent;
preferably, based on the total weight of the spent contact agent, the spent contact agent has a charcoal content of 0.5-5.0 wt %.

30. The processing method according to claim 1, characterized in that, the regeneration is carried out in a dense-phase fluidized bed regenerator; preferably, the regeneration condition includes: the residence time of an introduced gas (air) is 0.5-60s, preferably 1.0-10s, the dense bed has a gasification temperature of 600-750° C., preferably 600-700° C., the introduced gas is a gas having an oxygen gas content of 10-50 vol %, the dense bed has a linear velocity of 0.05-0.6 m/s, e.g., 0.2-0.4 m/s.

31. The processing method according to claim 1, characterized in that, the method further comprises:
recycling at least a part of a gas oil fraction from the separation unit to the viscosity reduction unit for waste plastics for reprocessing;
preferably, the weight ratio of the gas oil fraction to be reprocessed to the waste plastic to be treated is 0.2-5.0:1, e.g., 0.2-2:1;
preferably, a fraction with a distillation range of greater than 350° C. obtained by separation with the separation unit is used as the gas oil fraction.

32. The processing method according to claim 1, characterized in that, before step S1, the method further comprises:
a chlorine-containing waste plastic raw material is fed into a heat melting-dehydration-dechlorination unit for waste plastics of a heat melting-dehydration-dechlorination-comminution unit for waste plastics, and the chlorine-containing waste plastic raw material is subjected to melting-dehydration treatment at a first temperature condition to produce a dehydrated waste plastic;
then the dehydrated waste plastic is heated to a second temperature for dechlorination treatment to produce a dehydrated and dechlorinated waste plastic and a hydrogen chloride-containing gas;
the dehydrated and dechlorinated waste plastic is subjected to cooling treatment and comminution treatment successively in a cooling and comminution unit to produce dehydrated and dechlorinated waste plastic particles; the dehydrated and dechlorinated waste plastic particles are sent to the liquefaction unit for waste plastics; or the dehydrated and dechlorinated waste plastic is directly sent to the liquefaction unit for waste plastics.

33. The processing method according to claim 32, characterized in that, the heat melting-dehydration-dechlorination unit of the heat melting-dehydration-dechlorination-comminution unit for waste plastics includes a second screw-type heating transportation equipment and a vacuum device communicated with the second screw-type heating transportation equipment; preferably, the second screw-type heating transportation equipment is a twin screw-type or single screw-type transportation equipment;
preferably, the condition of the melting-dehydration treatment includes: the first temperature is 100-170° C., e.g., 120-150° C.; the time is 0.05-1h, e.g., 0.05-0.5h; the feeding rate of the chlorine-containing waste plastic raw material is 5-5000 kg/h, e.g., 100-4000 kg/h; preferably, the heating rate of the melting-dehydration treatment is 30-200° C./min, e.g., 50-100° C./min;
preferably, the condition of the dechlorination treatment includes: the second temperature is 150-370° C., e.g., 220-350° C., or 300-330° C.; the time is 0.05-0.5h, e.g., 0.1-0.2 h; the vacuum degree is 50-300 mmHg, e.g., 50-150 mmHg; preferably, the heating rate from the first temperature up to the second temperature is 50-200° C./min, e.g., 50-150° C./min;
optionally, the dehydrated and dechlorinated waste plastic particles obtained by the comminution treatment have a particle diameter of 100-2000 μm.

34. The processing method according to claim 1, characterized in that, before step S1, the method further comprises:
a chlorine-containing waste plastic raw material is sent to a preliminary melting-liquefaction-dechlorination unit for waste plastics to perform a heat melting-dechlorination treatment to produce a hydrogen chloride-containing gas phase material and a dechlorinated waste plastic material;
the dechlorinated waste plastic material is sent to the liquefaction unit for waste plastics; or
the dechlorinated waste plastic material is subjected to cooling treatment and comminution treatment successively to produce dechlorinated waste plastic particles; the dechlorinated waste plastic particles are sent to the liquefaction unit for waste plastics.

35. The processing method according to claim 34, characterized in that, the preliminary melting-liquefaction-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment;
the condition of the heat melting-dechlorination treatment includes: the feeding rate is 5-5000 kg/h, e.g., 100-4000 kg/h; the outlet temperature is 150-370° C., e.g., 300-330° C., the reaction time is 0.1-0.5h, e.g., 0.1-0.3 h; the vacuum degree of the preliminary melting-liquefaction-dechlorination unit for waste plastic is 50-300 mmHg, e.g., 50-150 mmHg;
preferably, the dechlorinated waste plastic particles obtained with the comminution treatment have a particle diameter of 100-2000 μm.

36. The processing method according to claim 32, characterized in that, the chlorine-containing waste plastic raw material is a thermoplastic plastic that meets one or more of the following conditions:
(1) the sum of the mass of the C and H elements of the plastic accounts for 50% or more of the total mass of the plastic, e.g. 60% or more; and/or
(2) the number average molecular weight of the plastic can be 1,000-2,000,000, for example, 2,000-300,000, or 5,000-100,000; and/or
(3) the S content of the plastic is 0.5% or less, e.g. 0.1% or less; and/or
(4) the plastic is chlorine-containing or chlorine-free, preferably chlorine-containing; and/or
(5) the plastic contains only one polymer or contains two or more polymers; and/or
(6) the plastic is or contains waste plastics; and/or
(7) the N content of the plastic is 10% or less by weight, e.g. 5% or less, 4% or less, 3% or less, 2% or less, or 1% or less; and/or
(8) the S content of the plastic is 1% or less by weight, e.g. 0.5% or less, 0.4% or less, 0.3% or less, 0.2% or less, or 0.1% or less; and/or
(9) examples of polymers constituting plastics include, but are not limited to, polyethylene (PE) such as low-density polyethylene (LDPE) and high-density polyethylene (HDPE), polystyrene (PS), polypropylene (PP), polyethylene terephthalate (PET) and polyvinyl chloride (PVC).

37. The processing method according to claim 34, characterized in that, the chlorine-containing waste plastic raw material is a thermoplastic plastic that meets one or more of the following conditions:
(1) the sum of the mass of the C and H elements of the plastic accounts for 50% or more of the total mass of the plastic, e.g. 60% or more; and/or
(2) the number average molecular weight of the plastic can be 1,000-2,000,000, for example, 2,000-300,000, or 5,000-100,000; and/or
(3) the S content of the plastic is 0.5% or less, e.g. 0.1% or less; and/or
(4) the plastic is chlorine-containing or chlorine-free, preferably chlorine-containing; and/or
(5) the plastic contains only one polymer or contains two or more polymers; and/or
(6) the plastic is or contains waste plastics; and/or
(7) the N content of the plastic is 10% or less by weight, e.g. 5% or less, 4% or less, 3% or less, 2% or less, or 1% or less; and/or
(8) the S content of the plastic is 1% or less by weight, e.g. 0.5% or less, 0.4% or less, 0.3% or less, 0.2% or less, or 0.1% or less; and/or
(9) examples of polymers constituting plastics include, but are not limited to, polyethylene (PE) such as low-density polyethylene (LDPE) and high-density polyethylene (HDPE), polystyrene (PS), polypropylene (PP), polyethylene terephthalate (PET) and polyvinyl chloride (PVC).

38. The processing method according to claim 32, characterized in that, the method further comprises:
the hydrogen chloride-containing gas is sent to a hydrogen chloride absorption unit to contact a hydrogen chloride absorbent to perform a hydrogen chloride absorption treatment, optionally, the hydrogen chloride-containing gas is sent to a hydrogen chloride absorption unit under the action of a vacuum system;
wherein the hydrogen chloride absorbent is water or an alkali solution with a pH value greater than 7; optionally, the alkali solution comprises one or more of a sodium hydroxide solution, a potassium hydroxide solution, a calcium hydroxide solution, a sodium bicarbonate solution, a sodium carbonate solution and an ammonia solution.

39. The processing method according to claim 34, characterized in that, the method further comprises:
the hydrogen chloride-containing gas is sent to a hydrogen chloride absorption unit to contact a hydrogen chloride absorbent to perform a hydrogen chloride absorption treatment, optionally, the hydrogen chloride-containing gas is sent to a hydrogen chloride absorption unit under the action of a vacuum system;
wherein the hydrogen chloride absorbent is water or an alkali solution with a pH value greater than 7; optionally, the alkali solution comprises one or more of a sodium hydroxide solution, a potassium hydroxide solution, a calcium hydroxide solution, a sodium bicarbonate solution, a sodium carbonate solution and an ammonia solution.

40. A processing system of plastics, characterized in that the system comprises: a liquefaction unit, a viscosity reduction unit, a cracking reaction unit, and a separation unit;
the liquefaction unit comprises an inlet for the plastic to be treated and an outlet for the liquefied plastic, and the liquefaction unit is configured to liquefy the plastic to be treated, preferably, the liquefaction unit has a rapid conveying mechanism so that the residence time of the plastic to be treated in the liquefaction unit is 5-30 minutes, for example, 5-20 minutes, 5-15 minutes;
the viscosity reduction unit comprises an inlet for liquefied plastic, an outlet for liquid phase material and an outlet for dry gas, and the viscosity reduction unit is configured to perform a heat treatment on the liquefied plastic to reduce its viscosity to form a liquid phase material;
the cracking reaction unit comprises an inlet for cracking raw material and an outlet for reaction product; the inlet for cracking raw material is communicated with the outlet for liquid phase material of the viscosity reduction unit, and the cracking reaction unit is configured to perform a cracking reaction treatment on the liquid phase material;
the separation unit includes a separation inlet, an outlet for dry gas, an outlet for liquefied gas, an outlet for gasoline fraction, an outlet for diesel fraction and an outlet for gas oil fraction; the separation inlet is communicated with the outlet for reaction product of the contact-cracking reaction unit, the separation unit is configured to perform a separation treatment on the reaction product.

41. The processing system according to claim 40, characterized in that, the system includes a liquefaction unit for waste plastics, a viscosity reduction unit for waste plastics, a contact-cracking reaction unit, a separation unit and a regeneration unit;
the liquefaction unit for waste plastics comprises an inlet for the waste plastic to be treated and an outlet for liquefied waste plastic, and the liquefaction unit for waste plastic is configured to liquefy the waste plastic to be treated;
the viscosity reduction unit for waste plastics includes an inlet for liquefied waste plastics, an outlet for liquefied waste plastic oil and an outlet for a first dry gas, the viscosity reduction unit for waste plastic is configured to perform viscosity reduction treatment on the liquefied waste plastics;
the contact-cracking reaction unit includes an inlet for cracking raw material, an inlet for contact agent, an outlet for reaction product and an outlet for spent contact agent; the inlet for cracking raw material is communicated with the outlet for liquefied waste plastic oil of the viscosity reduction unit for waste plastics, the contact-cracking reaction unit is configured to perform a cracking reaction treatment on the liquefied waste plastic oil;
the separation unit includes a separation inlet, an outlet for a second dry gas, an outlet for liquefied gas, an outlet for gasoline fraction, an outlet for diesel fraction and an outlet for gas oil fraction; the separation inlet is communicated with the outlet for reaction product of the contact-cracking reaction unit, the separation unit is configured to perform a separation treatment on the reaction product;
the regeneration unit includes an inlet for spent contact agent, an inlet for oxygen-containing gas, an outlet for regenerated contact agent and an outlet for regeneration flue gas; the regeneration unit is configured to regenerate the spent contact agent in the presence of oxygen gas to produce a regenerated contact agent and a regeneration flue gas; the outlet for regenerated contact agent is communicated with the inlet for contact agent of the contact-cracking reaction unit.

42. The processing system according to claim 40, characterized in that the processing system comprises: a liquefaction unit for waste plastics, a viscosity reduction unit for waste plastics, a material heating unit, a pyrolysis reaction unit and a separation unit;
the liquefaction unit for waste plastics comprises an inlet for the waste plastic to be treated and an outlet for liquefied waste plastic, and the liquefaction unit for waste plastic is configured to liquefy the waste plastic to be treated;
the viscosity reduction unit for waste plastics includes an inlet for liquefied waste plastics and an outlet for liquefied waste plastic oil, the viscosity reduction unit for waste plastic is configured to perform viscosity reduction treatment on the liquefied waste plastics;
the material heating unit includes a heating inlet and a heating outlet, the heating inlet is communicated with the outlet for liquefied waste plastic oil of the viscosity reduction unit for waste plastics, the heating unit is configured to heat the viscosity-reduced liquefied waste plastic oil;
the pyrolysis reaction unit includes an inlet for pyrolysis reactant and an outlet for pyrolysis product, the inlet for pyrolysis reactant is communicated with the heating outlet of the heating unit, the pyrolysis reaction unit is configured to perform the pyrolysis reaction treatment on the high-temperature liquefied waste plastics;
the separation unit includes a separation inlet, an outlet for dry gas, an outlet for liquefied gas, an outlet for gasoline fraction, an outlet for diesel fraction and an outlet for gas oil fraction; the separation inlet is communicated with the outlet for pyrolysis product of the pyrolysis reaction unit, the separation unit is configured to perform the separation treatment on the pyrolysis product.

43. The processing system according to claim 40, characterized in that the viscosity reduction unit for waste plastics further comprises at least one viscosity reduction reactor,
the viscosity reduction reactor is preferably an adiabatic reactor; and/or
the viscosity reduction reactor is preferably provided with a temperature-control and heating device so that it can be achieved that the temperature of the material sent to the reactor does not change significantly, wherein “the temperature of the material sent to the reactor does not significantly change” means that the temperature is maintained within a range of 90%-110%, e.g. 92%-108%, or 95%-105%, or 98%-102% of the temperature of the material sent to the reactor, and the temperature of the material sent to the reactor is represented by the reactor outlet temperature;
optionally, the viscosity reduction reactor provides an inlet for liquefied waste plastics, an outlet for liquefied waste plastic oil and optionally an outlet for a first dry gas of the viscosity reduction unit for waste plastics.

44. The processing system according to claim 40, characterized in that the processing system further comprises a heat melting-dehydration-dechlorination unit for waste plastics, a cooling and comminution unit and a hydrogen chloride absorption unit;
the heat melting-dehydration-dechlorination unit for waste plastics includes an inlet for chlorine-containing waste plastic raw material, an outlet for dehydrated and dechlorinated waste plastic and an outlet for hydrogen chloride-containing gas; the heat melting-dehydration-dechlorination unit for waste plastic is configured to perform the melting-dehydration treatment and dechlorination treatment on chlorine-containing waste plastic raw material;
the cooling and comminution unit is configured to perform the cooling treatment and comminution treatment on the dehydrated and dechlorinated waste plastic from the heat melting-dehydration-dechlorination unit for waste plastics;
the hydrogen chloride absorption unit includes an inlet for hydrogen chloride-containing gas phase material and a hydrogen chloride absorbent; the inlet for hydrogen chloride-containing gas phase material is communicated with the outlet for hydrogen chloride-containing gas of the heat melting-dehydration-dechlorination unit for waste plastics;
preferably, the regeneration unit further comprises an inlet for dry gas, the inlet for dry gas is communicated with the outlet for a first dry gas of the viscosity reduction unit for waste plastics and/or the outlet for a second dry gas of the separation unit;
optionally, a connecting pipeline between the inlet for cracking raw material of the contact-cracking reaction unit and the outlet for liquefied waste plastic oil of the viscosity reduction unit for waste plastic is provided with a steam inlet;
preferably, the liquefaction unit for waste plastics includes a heating liquefaction transportation equipment; optionally, the heating liquefaction transportation equipment include a first screw-type heating transportation equipment; preferably, the first screw-type heating transportation equipment is a twin screw-type heating transportation equipment with heating;
preferably, the heat melting-dehydration-dechlorination unit for waste plastics includes a second screw-type heating transportation equipment and a vacuum device communicated with the second screw-type heating transportation equipment; preferably, the second screw-type heating transportation equipment is a twin screw-type transportation equipment.

45. The processing system according to claim 40, characterized in that the system further comprises a preliminary melting-liquefaction-dechlorination unit for waste plastics and a hydrogen chloride absorption unit;
the preliminary melting-liquefaction-dechlorination unit for waste plastics includes an inlet for chlorine-containing waste plastic raw material, an outlet for hydrogen chloride-containing gas phase material and an outlet for dechlorinated waste plastics liquid phase material, the preliminary melting-liquefaction-dechlorination unit for waste plastic is configured to perform the heat melting-dechlorination treatment on chlorine-containing waste plastic raw material; the outlet for dechlorinated waste plastics liquid phase material is communicated with the inlet for the waste plastic to be treated of the liquefaction unit for waste plastics;
the hydrogen chloride absorption unit includes an inlet for hydrogen chloride-containing gas phase material, a hydrogen chloride absorbent and an outlet for dechlorinated dry gas; the inlet for hydrogen chloride-containing gas phase material is communicated with the outlet for hydrogen chloride-containing gas phase material of the preliminary melting-liquefaction-dechlorination unit for waste plastics;
preferably, the liquefaction unit for waste plastics includes a heating liquefaction transportation equipment; optionally, the heating liquefaction transportation equipment include a first screw-type heating transportation equipment; preferably, the first screw-type heating transportation equipment is a twin screw-type or single screw-type heating transportation equipment with heating;
preferably, the preliminary melting-liquefaction-dechlorination unit for waste plastics includes a second screw-type heating transportation equipment and a vacuum device communicated with the second screw-type heating transportation equipment; preferably, the second screw-type heating transportation equipment is a twin screw-type or single screw-type transportation equipment;
preferably, the viscosity reduction unit for waste plastics further comprises an inlet for cycle oil; the inlet for cycle oil is communicated with the outlet for gas oil fraction of the separation unit;
optionally, the preliminary melting-liquefaction-dechlorination unit for waste plastics further comprise an outlet for non-condensing gas.
